(19) United States
(12) Patent Application Publication
(10) Pub. No.: US 2026/0059544 A1
(43) Pub. Date: Feb. 26, 2026

(54) TECHNIQUES FOR COMMUNICATING MULTIPLE REPETITIONS OF A TRANSPORT BLOCK TECHNICAL FIELD

(71) Applicant: Lenovo (United States) Inc., Morrisville, NC (US)

(72) Inventors: Hossein Bagheri, Dearborn Heights, MI (US); Vijay Nangia, Woodridge, IL (US); Karthikeyan Ganesan, Nauheim (DE)

(21) Appl. No.: 19/373,277

(22) Filed: Oct. 29, 2025

(51) Int. Cl. H04W 72/232; H04L 27/26

(52) U.S. Cl. CPC H04W 72/232; H04L 27/261

(57) ABSTRACT

Various aspects of the present disclosure relate to receiving a downlink control information (DCI) including a grant for a set of repetitions of a transport block (TB); generating a plurality of repetition subsets from the set of repetitions for the TB, where the plurality of repetition subsets includes a first repetition subset including a first number of consecutive repetitions of the TB, and a second repetition subset including a second number of consecutive repetitions of the TB; and transmitting the TB according to the plurality of repetition subsets, where each repetition subset is temporally offset from a subsequent repetition subset of the plurality of repetition subsets, and where a value of a respective offset between repetition subsets of the plurality of repetitions subsets is based at least in part on the received DCI.

### TECHNICAL FIELD

The present disclosure relates to wireless communications, and more specifically to techniques for processing (e.g., determining, generating, segmenting, transmitting, receiving, or the like) a set of repetitions of a transport block (TB).

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G) radio access technology, etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of””) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to cause the UE to receive a downlink control information (DCI) including a grant for a set of repetitions of a TB; generate a plurality of repetition subsets from the set of repetitions for the TB, where the plurality of repetition subsets includes a first repetition subset including a first number of consecutive repetitions of the TB, and a second repetition subset including a second number of consecutive repetitions of the TB; and transmit the TB according to the plurality of repetition subsets, where each repetition subset is temporally offset from a subsequent repetition subset of the plurality of repetition subsets, and where a value of a respective offset between repetition subsets of the plurality of repetitions subsets is based at least in part on the received DCI.

A processor for wireless communication is described. In certain implementations, the processor may implement, or may be implemented by, a UE. The processor may be configured to, capable of, or operable to receive a DCI including a grant for a set of repetitions of a TB; generate a plurality of repetition subsets from the set of repetitions for the TB, where the plurality of repetition subsets includes a first repetition subset including a first number of consecutive repetitions of the TB, and a second repetition subset including a second number of consecutive repetitions of the TB; and transmit the TB according to the plurality of repetition subsets, where each repetition subset is temporally offset from a subsequent repetition subset of the plurality of repetition subsets, and where a value of a respective offset between repetition subsets of the plurality of repetitions subsets is based at least in part on the received DCI.

A method performed or performable by a UE is described. The method may include receiving a DCI including a grant for a set of repetitions of a TB; generating a plurality of repetition subsets from the set of repetitions for the TB, where the plurality of repetition subsets includes a first repetition subset including a first number of consecutive repetitions of the TB, and a second repetition subset including a second number of consecutive repetitions of the TB; and transmitting the TB according to the plurality of repetition subsets, where each repetition subset is temporally offset from a subsequent repetition subset of the plurality of repetition subsets, and where a value of a respective offset between repetition subsets of the plurality of repetitions subsets is based at least in part on the received DCI.

A base station for wireless communication is described. The base station may be configured to, capable of, or operable to cause the base station to transmit, to a UE, a DCI message including a grant for a set of repetitions of a TB; and receive the TB according to a plurality of repetition subsets, where the plurality of repetition subsets includes a first repetition subset including a first number of consecutive repetitions of the TB and a second repetition subset including a second number of consecutive repetitions of the TB, where each repetition subset is temporally offset from a subsequent repetition subset of the plurality of repetitions subsets, and where a value of a respective offset between repetition subsets of the plurality of repetition subsets is based at least in part on the transmitted DCI.

A processor for wireless communication is described. The processor may be configured to, capable of, or operable to transmit, to a UE, a DCI message including a grant for a set of repetitions of a TB; and receive the TB according to a plurality of repetition subsets, where the plurality of repetition subsets includes a first repetition subset including a first number of consecutive repetitions of the TB and a second repetition subset including a second number of consecutive repetitions of the TB, where each repetition subset is temporally offset from a subsequent repetition subset of the plurality of repetitions subsets, and where a value of a respective offset between repetition subsets of the plurality of repetition subsets is based at least in part on the transmitted DCI.

A method performed or performable by a base station is described. The method may include transmitting, to a UE, a DCI message including a grant for a set of repetitions of a TB; and receiving the TB according to a plurality of repetition subsets, where the plurality of repetition subsets includes a first repetition subset including a first number of consecutive repetitions of the TB and a second repetition subset including a second number of consecutive repetitions of the TB, where each repetition subset is temporally offset from a subsequent repetition subset of the plurality of repetitions subsets, and where a value of a respective offset between repetition subsets of the plurality of repetition subsets is based at least in part on the transmitted DCI.

### BRIEF DESCRIPTION OF THE DRAWINGS

FIG. 1 illustrates an example of a wireless communications system, in accordance with aspects of the present disclosure.

FIGS. 2A and 2B illustrate examples of multiple sets of repetitions, in accordance with aspects of the present disclosure.

FIGS. 3 and 4 illustrate examples of repetition patterns, in accordance with aspects of the present disclosure.

FIGS. 5A through 5D illustrate examples of repetitions for communication of a TB, in accordance with aspects of the present disclosure.

FIG. 6 illustrates an example of a protocol stack, in accordance with aspects of the present disclosure.

FIG. 7 illustrates an example of a UE, in accordance with aspects of the present disclosure.

FIG. 8 illustrates an example of a processor, in accordance with aspects of the present disclosure.

FIG. 9 illustrates an example of a NE, in accordance with aspects of the present disclosure.

FIGS. 10 and 11 illustrate flowcharts of methods performed by a UE in accordance with aspects of the present disclosure.

FIGS. 12 and 13 illustrate flowcharts of methods performed by a NE in accordance with aspects of the present disclosure.

### DETAILED DESCRIPTION

A wireless communication system may support extended-range connectivity for massive internet-of-things (IoT) deployments. As used herein, “extended-range connectivity” refers to communication support for UE (e.g., IoT UEs) to maintain reliable wireless communication in coverage-limited environments while operating with limited power, limited bandwidth, limited signal quality, or the like, as might be typical in massive IoT deployments. To achieve extended-range connectivity, the wireless communication system may support (e.g., enable) repetitions of communication (e.g., control information, data) to ensure sufficient coverage. By repeating communication (e.g., transmission of control information and/or data) multiple times, UEs can combine the repetitions to increase the likelihood of successful decoding. The repeated communications may compensate for various factors, such as noise, poor signal strength, and/or signal distortion due to significant propagation loss or delays, through coherent or incoherent combining of the repetitions (e.g., coherent signal combining or incoherent signal combining). Thus, the accumulated signal energy is increased, the impact of noise is reduced (e.g., through noise averaging), and overall receiver sensitivity of the UEs is improved. However, supporting extended-range connectivity might conflict with the equally important objective of minimizing energy consumption within the system (e.g., NEs). Accordingly, it may be desirable to provide mechanisms that efficiently support massive IoT deployments by reducing energy consumption for NE while improving coverage and connectivity reliability for UEs.

The present disclosure provides techniques for improving repeated communication (e.g., transmission, reception) of a TB by segmenting (e.g., partitioning, chunking, clustering) a set of repetitions of the TB into multiple segments (also referred to as “repetition subsets”, “repetition chunks”, “repetitions clusters”, or “repetition bursts”). A NE may transmit, and a UE may receive, DCI including a grant for the set of repetitions of the TB. Based in part on the received DCI, the UE may segment the set of repetitions into multiple repetition segments. By way of example, the multiple repetition segments may include a first repetition segment comprising a first number of consecutive repetitions of the TB, and a second repetition segment comprising a second number of consecutive repetitions of the TB. In some examples, the segments are separated by one or more temporal gaps (also referred to as “inter-segment gaps,” “intra-set gaps,” “inter-chunk gaps,” “inter-cluster gaps,” or “inter-burst gaps”), such that each repetition segment may be temporally offset from a subsequent repetition segment. For example, a temporal gap may follow the end of the first repetition segment before the start of the second repetition segment, and so forth for the remaining repetition segments.

Additionally, or alternatively, each repetition within a respective repetition segment may be temporally offset from a subsequent repetition within the same respective repetition segment. For example, a temporal gap (also referred to as a “intra-segment gap”) may occur between each repetition of the first repetition segment and/or between each repetition of the second repetition segment, and so forth for the other repetition segments. The UE may transmit, and the NE may receive, the TB according to the multiple repetition segments. By enabling (e.g., configuring) gaps between repetition segments and/or repetitions within segments, UE and NE may reduce energy overhead and maintain high reliability in ultra-low-rate, repetition-based massive IoT scenarios.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

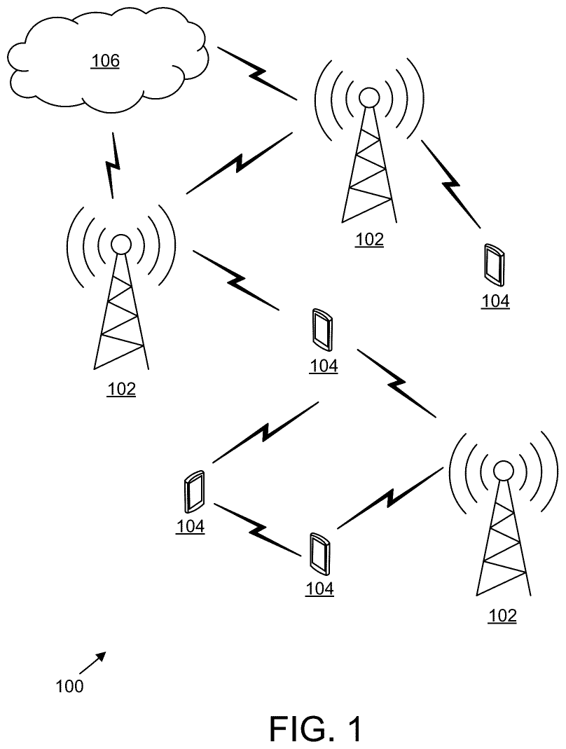

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various RATs. In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In some other implementations, the wireless communications system 100 may be a 6G radio (6GR) network, such as a 6G network. In other implementations, the wireless communications system 100 may be a combination of a 4G network and/or a 5G network and/or a 6G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6GR. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an IoT device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, X2, N2, N3, Xn, F1-C, F1-U, or another network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, X2, N2, N3, Xn, F1-C, F1-U, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., μ=2) may be associated with a third SCS value (e.g., 60 kHz) and a normal cyclic prefix or an extended cyclic prefix. A fourth numerology (e.g., μ=3) may be associated with a fourth SCS value (e.g., 120 kHz) and a normal cyclic prefix. A fifth numerology (e.g., μ=4) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHz-7.125 GHz), frequency range #2 (FR2) (e.g., 24.25 GHz-52.6 GHz), frequency range #3 (FR3) (e.g., 7.125 GHz-24.25 GHz), frequency range #4 (FR4) (e.g., 52.6 GHz-114.25 GHZ), frequency range #4a (FR4a) or frequency range #4-1 (FR4-1) (e.g., 52.6 GHz-71 GHZ), and frequency range #5 (FR5) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

In the wireless communication system 100, an NE 102 may transmit, and a UE 104 may receive, DCI including a resource grant for a set of repetitions of a TB. For example, the resource grant may be an uplink grant for a set of uplink resources on which a UE 104 is to transmit multiple repetitions of a TB. Additionally, or alternatively, the resource grant may be a downlink grant for a set of downlink resources on which a UE 104 is to receive multiple repetitions of a TB. For example, one or more of the NE 102 or the UE 104 may generate a plurality of repetition subsets from the set of repetitions for the TB, including at least the first repetition subset and a second repetition subset, each including a number of consecutive repetitions of the TB. The DCI may indicate a respective duration corresponding to each of the repetition subsets, respectively. Additionally, each repetition subset may be temporally offset from a subsequent repetition subset of the plurality of repetition subsets, and a value of a respective offset between repetition subsets of the plurality of repetitions subsets may be based at least in part on the DCI. The UE 104 may transmit, and the NE 102 may receive, the TB according to the plurality of repetition subsets. Additionally, or alternatively, the UE 104 may receive, and the NE 102 may transmit, the TB according to the plurality of repetition subsets.

In some cases, such as for narrowband (NB) internet-of-things (IoT) communication, TBs may be repeated over multiple subframes (e.g., up to 2048 repetitions), which may span up to 2048×10 subframes. In NB-IoT deployments, a number of repetitions may be indicated via DCI, for example, using at last two fields in a scheduling DCI (assuming one scheduled TB): a first field to indicate the number of repetitions and a second field to indicate the number of subframes per repetition. The narrowband physical downlink shared channel (NPDSCH) downlink data transmissions may occur after the last DCI carrying subframe, and the DCI-carrying subframes may be determined based on a first value (e.g., a configured value), a second value indicated in a field of the scheduling DCI, and a corresponding formula applied to those values.

In 5G, IoT non-terrestrial network (NTN) communication relies on repetitions to enhance coverage, and overcome the challenges of satellite communication, such as poor signal conditions and large propagation delays. However, since IoT UE pre-compensation is required for physical uplink shared channel (PUSCH) transmissions, i.e., to restore alignment in both the time and frequency domains against misalignments caused by satellite movement, a large set of uplink repetitions must be divided into smaller segments, with each segment mapped to a separate transmission occasion. This segmentation of NTN transmissions is configured through radio resource control (RRC) signaling.

Two types of drift are critical in the context of NTN communication: timing drift and frequency drift. Timing drift may be caused by variations in the round-trip propagation delay as the satellite moves relative to the UE, and can eventually exceed the cyclic prefix (CP) duration. When this happens, consecutive OFDM symbols begin to overlap, leading to inter-symbol interference (ISI). In parallel, frequency drift may result from Doppler shifts due to satellite velocity, which disrupts subcarrier orthogonality and produces inter-carrier interference (ICI).

To avoid these types of signal degradations, transmission repetitions in NTN must be split whenever the accumulated drift risks exceeding CP or frequency error tolerances. Splitting the transmission allows the UE to refresh its pre-compensation, thereby keeping both ISI and ICI within acceptable limits and ensuring reliable decoding.

Also in 5G NR, a UE may be scheduled with several repetitions of a TB in the uplink, e.g., via a single DCI. Repetition Types A & B refer to transmission schemes for physical uplink shared channel (PUSCH) and physical downlink shared channel (PDSCH) for the transmission of a data block multiple times across different time slots, e.g., to improve coverage and reliability.

In Repetition Type A, the UE repeats in the same symbols in multiple, separate slots. For Repetition Type A the DCI indicates the repetitions are indicated by the DCI, and the indication may be referred to as a start and length indicator value (SLIV) indication. In other words, each time slot contains a single repetition of the TB or data block, thus creating a distinct time gap between repetitions.

In Repetition Type B, the repetitions are back-to-back and occur in consecutive symbol sets, allowing for multiple repetitions within a single slot. For Repetition Type B, the DCI indicates the resources for the first transmission as well as the number of nominal repetitions. However, if a repetition overlaps with invalid symbols or slot boundary, it is split into two actual repetitions. The number of actual repetitions, hence, can be larger than the number of nominal repetitions.

To support optimizing the repeated transmission of a TB, e.g., for transmission or reception by bandwidth limited and/or extended coverage devices (e.g., UEs 104), the TB may be scheduled with a set of repetitions, and the set of repetitions may be segmented into multiple segments (i.e., repetition subsets) that are separated by inter-segment gaps, thereby reducing energy overhead while maintaining reliability. The inter-segment gaps allow the network to confine transmissions or receptions corresponding to different UEs to a window of time, letting network sleep within inter-segment gaps.

In some examples, the segmentation is determined based on a scheduling DCI, which may indicate and/or define a set of repetition subsets with inter-segment gaps between successive repetition subsets.

In some examples, the segmentation is determined based on a non-scheduling DCI and/or based on a group-common DCI, which may indicate and/or define a set of gaps (e.g., inter-segment gaps) within a window of time. In an example, a UE 104 may be scheduled with a scheduling DCI to receive or transmit ‘N’ repetitions of a TB within a first time window, where the time window maybe implicitly indicated (e.g., by the number of repetitions and by the time resource indication for the first repetition) or expressly indicated by the non-scheduling DCI or group-common DCI.

In some implementations, the UE 104 may have already received (or may receive later than the scheduling DCI) a non-scheduling DCI or a group-common DCI indicating the set of gaps within a second window of time; wherein a subset of the gaps overlaps in time with the ‘N’ repetitions of the TB. In such implementations, the UE 104 may determine to drop the overlapped repetitions. Alternatively, the UE 104 may receive a time-shifted version of the overlapped repetitions, where the time-shifted versions do not overlap with the gaps.

In a related implementation, the scheduling DCI may indicate a third time window in addition to scheduling the ‘N’ repetitions of the TB within the first time window, where the third window includes the first time window and an additional time window (e.g., the additional time window occurs immediately after the first time window). In an example, the scheduling DCI may indicate ‘N’ repetitions, and ‘M’ repetitions, wherein ‘M’≥‘N’. Accordingly, the UE 104 would receive (or transmit) ‘N’ repetitions of the TB consecutively if no overlapping gap with the ‘N’ repetitions is indicated. In case of overlapping gap(s), the UE 104 may extend reception (or transmission) of the ‘N’ repetitions up to the time associated with the ‘M’ repetitions.

In an example, ‘N=100’, and ‘M=150’, and each repetition is scheduled in a slot (assume slot 1 corresponds to repetition 1). If there are two overlapping gaps corresponding to slots 20-30, and 75-90, then the UE 104 would receive/transmit in slots 1-19, 31-74, 91-127. Alternatively, if there are two overlapping gaps corresponding to slots 20-30, and 90-110, then the UE 104 would receive/transmit in slots 1-19, 31-89, 111-132. However, if there was no overlapping gap, then the UE 104 would receive/transmit in slots 1-100.

In another example, if the overlapping gaps are such that not all ‘N’ repetitions can be communicated via the ‘M’ slots, then the remaining un-communicated repetitions may be dropped (e.g., dropped by the NE 102 in case of a downlink transmission, or dropped by the UE 104 in case of an uplink transmissions). In an example, the scheduling DCI indication of ‘M>N’ may be valid only if the non-scheduling or group-common DCI—or in general, the gap indication-occurs enough time prior to the scheduling DCI or the first TB repetition or the first TB repetition that overlaps with the first gap.

In some examples, the scheduling DCI further indicates a set of hybrid automatic repeat request (HARQ) opportunities for at least a portion of the repetition subsets, where the receiving entity (e.g., NE 102 or UE 104) may transmit a positive acknowledgement (ACK), a negative acknowledgement (NACK), or no feedback, and the transmitting entity may terminate transmission of a remaining number of repetitions of the TB.

In some examples, the UE 104 may determine an updated repetition distribution (also referred to as a repetition pattern) according to a second DCI received after a first DCI which has scheduled an original repetition distribution. The repetition distribution can be in time domain or in frequency domain or a combination thereof.

In some examples, the DCI may indicate whether the NE 102 goes to sleep within each inter-segment gap and/or whether the rest of the repetitions should be communicated after the cell wakeup. In another example, if the duration of a gap is larger than a threshold (configured value or pre-defined value), then the UE 104 determines that the cell has entered a sleep mode, and certain corresponding cell functionalities are not available (e.g., channel state information reference signals (CSI-RS), control channel transmissions, paging messages, synchronization signal blocks (SSB), etc.).

In this disclosure, it is assumed that a UE 104 is scheduled to communicate (i.e., transmit or receive) multiple repetitions of the same TB. While the often described in the context of uplink transmissions, the below solutions also generally apply to downlink transmissions except where noted otherwise.

According to aspects of a first solution, a bandwidth limited and/or extended coverage UE 104 may be configured to communicate a TB, e.g., by transmitting or receiving a set of repetitions of the TB. Considering extended coverage, several repetitions may be needed; however, transmitting all the repetitions consecutively may not be as energy efficient, e.g., from network perspective.

For instance, two UE may be scheduled with uplink grants with different start times and/or with different numbers of repetitions. In some implementations, it may be more energy efficient if at least some of these repetitions are transmitted by the UEs during the same time window.

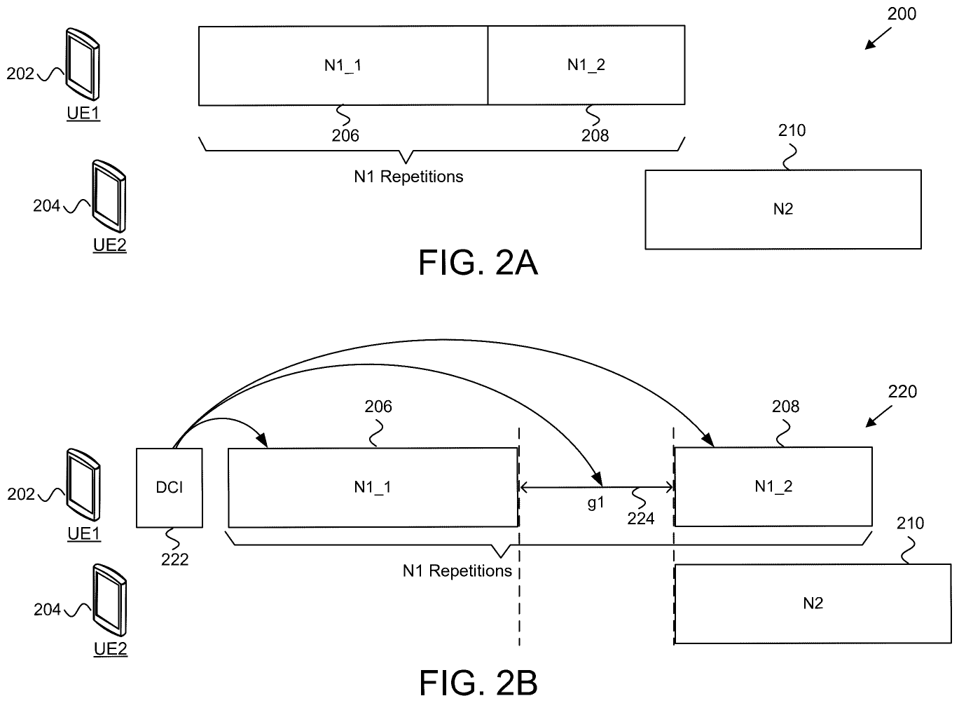

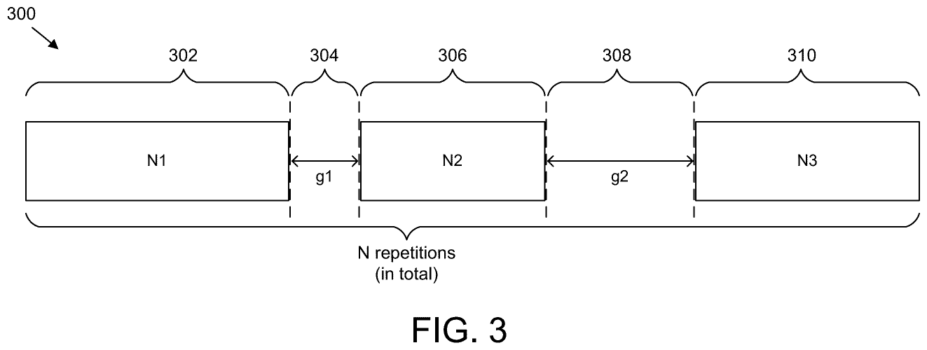

FIGS. 2A and 3B illustrate transmission alignment of multiple sets of repetitions for transmission of TBs by multiple UEs, in accordance with aspects of the present disclosure. A procedure for transmission alignment may implement or be implemented by aspects of the wireless communication system 100. For example, the procedure may include a first UE 202 (denoted “UE1”) and a second UE 204 (denoted “UE2”), each scheduled by an NE 102 with uplink resources for transmitting multiple repetitions of a TB. The first UE 202 and the second UE 204 may implement or be implemented by a plurality of UEs 104 as described herein.

FIG. 2A illustrates an example 200 of multiple sets of repetitions in accordance with aspects of the present disclosure. In some examples, the multiple sets of repetitions implement or are implemented by aspects of the wireless communications system 100. For example, the multiple sets of repetitions may be implemented by multiple UE 104 and/or multiple NE 102 as described with reference to FIG. 1. For example, the multiple sets of repetitions may be associated with transmission and/or reception of TBs by multiple UEs, including the UE 202 (UE1) and the UE 204 (UE2). In the example of FIG. 2A, multiple sets of repetitions may be associated with transmission of the TBs by the multiple UEs prior to transmission alignment.

An NE may allocate resources to the UE 202 for transmission of a set of N₁ repetitions of a first TB. Accordingly, the NE may transmit, and the UE 202 may receive, a scheduling DCI comprising a grant for the set of N₁ repetitions of the first TB. The set of N₁ repetitions for the first TB is dividable into sets of N_{1_1} and N_{1_2} repetitions, such that N₁=N_{1_1}+N_{1_2}. For example, the UE 202 may generate a plurality of repetition subsets by segmenting the set of N₁ repetitions into subsets of N_{1_1} and N_{1_2} repetitions for the first TB. In some examples, the UE 202 may perform transmission of the N_{1_1}+N_{1_2} repetitions consecutively. Additionally, the NE may allocate resources to the UE 204 for transmission of a set of N₂ repetitions for a second TB. Accordingly, the NE may also transmit, and the UE 204 may receive, a scheduling DCI comprising a grant for the set of N₂ repetitions of the second TB.

In the example of FIG. 2A, transmissions of the first TB and the second TB may be initially unaligned, for example, due to the NE allocating resources to the UE 202 for transmission of the first TB before allocating resources to the UE 204 for transmission of the second TB. This initial lack of time alignment (e.g., a partial transmission overlap between the first TB and the second TB), although relatively small, may result in increased energy consumption by the NE. Alternatively, the NE may transmit, and the UE 204 may receive, a configured grant (CG) including CG resources for transmission of the second TB. Put another way, the UE 204 may receive a recurring, semi-persistent allocation of resources, or a scheduled grant for transmission of data still being generated while the UE 202 begins transmission of the repetitions of the first TB.

FIG. 2B illustrates an example 220 of multiple sets of repetitions in accordance with aspects of the present disclosure. In some examples, the multiple sets of repetitions implement or are implemented by aspects of the wireless communications system 100. For example, the multiple sets of repetitions may be implemented by multiple UE 104 and/or multiple NE 102 as described with reference to FIG. 1. For example, the multiple sets of repetitions may be associated with transmission and/or reception of TBs by multiple UEs, including UE 202 (UE1) and UE 204 (UE2). In the example of FIG. 2B, multiple sets of repetitions may be associated with transmission of the TBs by the multiple UEs after transmission alignment. As used herein, transmission alignment refers to a procedure for aligning uplink and/or downlink transmissions among multiple UEs to create a time period during which no UEs are communicating with the network. Accordingly, with the transmission alignment, multiple UEs may begin communicating (i.e., transmitting and/or receiving) at a same time following a transmission gap, e.g., an intra-set gap for at least one or the UEs. Thus, one or more UEs may pause communication prior to completing a set of repetitions thereby forming the transmission gap.

An NE may transmit, and the UE 202 may receive, a scheduling DCI 222 that allocates a set of resources for communicating a set of N₁ repetitions of a first TB. In order to form a transmission gap (i.e., an intra-set gap 224) of length g₁, the scheduling DCI 222 may include information for segmenting the set of N₁ repetitions into two or more repetitions subsets, as described below. While not depicted in FIG. 2B, the NE may also transmit, and the UE 204 may receive, a second DCI that allocates (i.e., schedules) a second set of resources for communicating a set of N₂ repetitions of a second TB.

In the example 220 of FIG. 2B, based at least in part on the received scheduling DCI 222 (e.g., including the allocated set of resources), the UE 202 may generate a plurality of repetition subsets, e.g., by segmenting the set of N₁ repetitions into at least two repetition subsets, a first repetition subset 206 having N_{1_1} consecutive repetitions and a second repetition subset 208 having N_{1_2} consecutive repetitions, respectively. For example, the scheduling DCI 222 may include information indicative of the number of consecutive repetitions in each of the plurality of repetition subsets, such that the UE 202 generates the first repetition subset having N_{1_1} consecutive repetitions of the TB, and generates the second repetition subset having N_{1_2} consecutive repetitions of the TB. As another example, the scheduling DCI 222 may indicate the total number of repetitions (e.g., N₁ repetitions) and a gap value of an intra-set gap between the repetition subsets. Based on this information, the UE 202 may determine the number of consecutive repetitions in each of the plurality of repetition subsets (i.e., the first repetition subset of N_{1_1} repetitions and the second repetition subset of N_{1_2} repetitions, respectively). By indicating and/or triggering such a split and allowing proper/aligning gap between the repetition subsets of UE1, the NE can skip transmission/reception during an intra-set gap 224.

In some implementations, the scheduling DCI 222 may include information on generating the plurality of repetition subsets. For example, the scheduling DCI that allocates the uplink resources for the first TB may indicate the durations of the two repetition subsets and the length g₁ of the intra-set gap 224. The UE 202 may determine the number of consecutive repetitions for each repetition subset based at least in part on the indicated durations. Further, the UE 202 may determine the start of the second repetition subset (e.g., as an offset from the start of the first repetition subset, or from the end of the first repetition subset) based on the duration of the first repetition subset and the length g₁ of the intra-set gap 224.

As an alternative to expressly indicating the durations of the two repetition subsets, the scheduling DCI 222 may indicate a number of consecutive repetitions for each repetition subset, such that the UE 202 determines the durations of each repetition subset based at least in part on the indicated numbers of consecutive repetitions. Additionally, or alternatively, instead of expressly indicating the length g₁ of the intra-set gap 224, the scheduling DCI 222 may indicate an offset of the second repetition subset from the first repetition subset (or from the end of the first repetition subset). The UE 202 may determine the length g₁ of the intra-set gap 224 based at least in part on the indicated offset and/or the UE 202 may determine the start of the second repetition subset based on the indicated number of consecutive repetitions in the first repetition subset (and/or the determined duration of the first repetition subset) and the indicated offset (and/or the determined length g₁ of the gap 224). Beneficially, by the NE transmitting the indications of the repetition subset sizes (i.e., duration and/or number of consecutive repetitions) and the intra-set gap(s), the NE is able to cause transmission alignment, thereby forming a transmission gap, and the NE is able to enter the lower-power mode and reduce power costs.

In some implementations, having the NE transmit a single scheduling DCI 222 that schedules all repetitions of a TB instead of multiple scheduling DCIs that each schedule a subset of the repetitions (e.g., N₁, and N₂) can save energy at the NE and the UEs 202, 204 and releases (e.g., de-allocates) resources (e.g., control channel resources), especially considering the NE may have to repeat transmission of a particular DCI to enhance the coverage. For example, NB-IoT communication uses a single DCI to schedule multiple consecutive repetitions of a TB. Accordingly, the NE and the UEs 202, 204 may save energy when the NE transmits the single scheduling DCI 222 that schedules all repetitions of the TB.

Referring more generally to FIG. 1, in some implementations of the wireless communication system 100, a UE 104 may be scheduled with ‘N’ repetitions constituting, e.g., N₁, N₂, . . . , N_{w} repetition subsets, such that N=N₁+N₂+ . . . +N_{w}. The UE 104 may receive DCI indicating a number of repetition subsets to generate, or may instead be configured (e.g., by RRC signaling) with the number of repetition subsets to generate. Alternatively, the number of repetition subsets to generate (i.e., by the UE 104 for an uplink transmission, or by the NE 102 for a downlink transmission) may be predetermined or may be derived by the NE 102 and UEs 104 according to rules known to the NE 102 and UEs 104.

In various implementations, a UE 104 may receive a scheduling DCI a pattern of repetitions of a TB. In general, a pattern of repetitions includes at least the N₁, N₂, . . . , N_{w} repetition subsets. In certain implementations, the NE 102 may configure the UE 104 (e.g., by RRC signaling) with an intra-set gap between each repetition subset. Alternatively, the NE 102 may indicate the intra-set gap to the UE 104, e.g., in the scheduling DCI that schedules the repetition subsets, or in non-scheduling DCI. In certain other implementations, the NE 102 may configure the UE 104 (e.g., by RRC signaling) with an offset from the beginning of one repetition subset to the beginning of a next (i.e., subsequent) repetition subset. Alternatively, the NE 102 may indicate the offset to the UE 104, e.g., in the scheduling DCI that schedules the repetition subsets, or in non-scheduling DCI.

In some implementations, if an intra-set gap is larger than a threshold (e.g., 10 slots) then the UE 104 may assume (e.g., determine) that the NE 102 enter a lower-power mode during that gap or a subset of the gap duration. For example, the NE 102 may operate in a first power mode (e.g., a normal operating mode) outside a gap period, and may operate in a second, lower-power mode (also referred to as a sleep mode or a sleep state) within the gap periods that satisfy the threshold. In the second power mode, the NE 102 may power down one or more components or circuitry to conserve energy. Accordingly, the NE 102 may determine, based at least in part on the scheduled grants (i.e., of uplink and/or downlink resources) whether a transmission gap period (e.g., comprising one or more intra-set gaps corresponding to one or more UEs) of sufficient length is scheduled and if true, then enter the lower-power mode during that gap period or a subset of the gap duration, such that one or more components or circuitry of the NE 102 associated with transmission of downlink control and/or data signals and/or with the reception of uplink control and/or data signals are powered down during the gap period or subset thereof.

In certain implementations, the NE 102 may send an indication (e.g., a DCI (scheduling DCI or non-scheduling DCI) or in a system information (SI) broadcast (or on-demand SI transmission) that it intends to go to sleep during intra-set gaps and/or may send the threshold to the UE 104. Moreover, the NE 102 may schedule the grants of uplink and/or downlink resources for communication a set of repetitions for a TB, and may further send to the UE 104 (i.e., transmit in DCI and/or RRC signaling) indications of one or more intra-set gaps, to create an intra-set gap of sufficient size to that triggers the NE 102 transitioning to the lower-power mode. Accordingly, the UE 104 may assume that the NE 102 goes to sleep during that intra-set gap or a subset of the gap duration when the gap length exceeds the threshold, and thus the UE 104 may abstain from communicating (e.g., transmitting or receiving) with the NE 102 during the intra-set gap. In certain implementations, the subset of the gap during which the NE 102 is in a lower-power mode may be predetermined or configured prior to the intra-set gap.

In an example, the NE 102 and the UE 104 may resume communicating repetitions after a gap (e.g., intra-set gap) only when the gap is associated with a micro-sleep, where micro-sleep refers to a micro-sleep mode (short duration) where only unneeded radio frequency (RF) transmitter/receiver chains and unneeded baseband chains of the NE 102 are powered down, but synchronization and reference signals (e.g., SSB, CSI-RS) are transmitted, and control-plane functions remain active. In another example, the NE 102 and the UE 104 may drop one or more (i.e., up to all) of the remaining repetitions after a deep sleep, where deep sleep refers to a deep-sleep mode (long duration) where the cell is effectively off-air, such that no SSB, paging, or CSI-RS transmissions are made by the NE 102. During the deep-sleep mode, the NE 102 may release an active cell context and enter a cell-level discontinuous transmission (DTX) mode.

FIG. 3 illustrates an example of a repetition pattern 300 for communication of a TB in accordance with aspects of the present disclosure. In some examples, the repetition pattern 300 may be implemented by aspects of the wireless communication system 100. For example, an NE 102 may configure at least one UE 104 to transmit a respective TB in accordance with the repetition pattern 300. In another example, the NE 102 may configure the at least one UE 104 to receive a respective TB in accordance with the repetition pattern 300. In the example of FIG. 3, the repetition pattern 300 for transmission of the TB may include multiple repetition subsets and gaps between successive repetition subsets, such that the UE 104 transmits (alternatively, the NE 102 transmits) and the NE 102 receives (alternatively, the UE 104 receives) a set of repetitions for the TB according to the repetition pattern 300.

For the uplink scenario, the NE 102 may transmit a scheduling DCI to a UE 104 with an uplink grant for transmission of a TB using N repetitions, where the UE 104 is configured to transmit a set of N repetitions of the TB according to the repetition pattern 300. For the downlink scenario, the NE 102 may transmit a scheduling DCI to a UE 104 with a downlink grant for reception of a TB using N repetitions, where the UE 104 is configured to receive a set of N repetitions of the TB according to the repetition pattern 300.

In one implementation, the NE 102 transmits (and the UE 104 receives) a scheduling DCI that includes an indication of the repetition pattern 300. For example, the scheduling DCI may contain an index that points to a particular pattern from a set of pre-configured patterns, where the pre-configured patterns are communicated to the UE via RRC signaling, SI broadcast, or on-demand SI transmission, or the like. In another example, the scheduling DCI may include a set of parameters defining the repetition pattern 300, including a duration of each repetition subset (and/or a number of consecutive repetitions for each repetition subset) and a spacing (i.e., gap) between each repetition subset. The gaps between successive repetition subsets are also referred to as “intra-set gaps.” In another implementation, the NE 102 may transmit (and the UE 104 may receive) a non-scheduling DCI that includes the indication of the repetition pattern 300, such as the index or set of parameters described above. In yet other implementations, the NE 102 may use RRC signaling to transmit the indication of the repetition pattern 300, such as the index or set of parameters described above.

As depicted in FIG. 3, the UE 104 may receive DCI scheduling a grant of resources for N repetitions (in total) of a TB and determine the repetition pattern 300. In the depicted example, the repetition pattern 300 consists of a first repetition subset 302 including N₁ repetitions of the TB, a first intra-set gap 304 of duration g₁, a second repetition subset 306 including N₂ repetitions of the TB, a second intra-set gap 308 of duration g₂, and a third repetition subset 310 including N₃ repetitions of the TB. In some implementations, the UE 104 configured with the repetition pattern 300 may be an IoT UE or a low-power, wide-area (LPWA) UE, or an extended coverage UE.

In certain implementations, the scheduling DCI may indicate a pattern of unavailable slots. With reference to FIG. 3, the NE 102 may transmit (and the UE 104 receive) the scheduling DCI which contains an indication that a plurality of slots corresponding to the first intra-set gap 304 of duration g₁ and the second intra-set gap 308 of duration g₂ are unavailable. In some examples, the NE 102 may transmit (and the UE 104 receive) scheduling DCI containing an indication of the total number N repetitions (e.g., where N=N₁+N₂+N₃) and the unavailable slots corresponding to gaps the first intra-set gap 304 of duration g₁, and the second intra-set gap 308 of duration g₂. For instance, the scheduling DCI may indicate 100 repetitions (i.e., N=100), and indicate pairs {(0→15), (65→75), (105→115)} which means: the first repetition subset 302 starts 15 slots after the last DCI slot; after 50 repetitions (i.e., assuming one repetition per slot), there is a first intra-set gap 304 of 10 slots, then the second repetition subset 306 consists of the next 30 consecutive repetitions, and then a second intra-set gap 308 of 20 slots, and at last, the third repetition subset 310 consists of 20 consecutive repetitions.

In some implementations, the NE 102 may configure one or more of the UEs 104 with a set of repetition patterns of different values for N₁, N₂, . . . , N_{w} along with g₁, g₂, . . . , g_{w-1} may be configured, e.g., as a table. In one example, each row of the table corresponds to a specific pattern, and each element in a respective row indicates the number of repetitions for a respective repetition subset or a duration of a respective intra-set gap. Accordingly, after configuring the one or more UEs 104, the NE 102 can transmit an index (e.g., a row of the table) pointing to the previously configured set of patterns, and the UE 104 may determine the particular pattern to use based on the received index. By indicating the index of a previously configured set of repetition patterns, the NE 102 can communicate the repetition pattern more efficiently and reduce communication overhead.

In certain implementations, the NE 102 and the UEs 104 assume that any invalid symbols or slots in a transmission configuration for the cell (i.e., an overall pattern of uplink and downlink symbols, for example arranged into uplink slots, downlink slots, or mixed-use slots) are not counted towards an intra-set gap between successive repetition subsets. In one example, for downlink transmission with repetitions, the NE 102 and the UEs 104 are configured (e.g., programmed) to recognize that the indicated intra-set gap value does not take into account uplink slots (or uplink symbols) within the frames containing the repetition subsets, and thus the uplink symbols present in the cell transmission configuration are ignored when determining the intra-set gap and the intra-set gap value only considers downlink symbols during the relevant time period. In another example, for uplink transmission with repetitions, the NE 102 and the UEs 104 are configured (e.g., programmed) to recognize that the indicated intra-set gap value does not take into account downlink slots (or downlink symbols) within the frames containing the repetition subsets, and thus the downlink symbols present in the cell transmission configuration are ignored when determining the intra-set gap and the intra-set gap value only considers uplink symbols during the relevant time period.

In certain implementations, instead of transmitting the values of N₁, N₂, . . . , N_{w}, the NE 102 may transmit DCI (e.g., scheduling DCI) that indicates the total number of repetitions ‘N’, and that further indicates a sequence of fractions, e.g., (or a sequence of integers representative of fractions, e.g., {2, 1, 3}) which denote the number of repetitions subsets and the number of TB repetitions including each repetitions subset. For example, the NE 102 may transmit (and the UE 104 may receive) the fraction sequence {⅓, ⅙, ½} (or the integer sequence {2, 1, 3}) to indicate the set of repetitions is to be segmented into three (3) repetition subsets with N₁=N/3, N₂=N/6, and N₃=N/2. Beneficially, by indicating the fraction/integer sequence, the NE 102 can communicate the repetition pattern more efficiently and reduce communication overhead.

In some implementations, the NE 102 may later transmit (and the UE 104 may receive) an indication to update the repetition pattern, such as a change to the duration of the intra-set gaps between successive repetition subsets. For example, the scheduling change may be based on a network load (e.g., other users' data needs), buffer status reporting (BSR) received from other UEs 104, etc. In certain implementations, to indicate the change of repetition pattern or gap duration the NE 102 may transmit (and the UE 104 may receive) a second DCI (e.g., non-scheduling DCI) for updating the repetition pattern, or the gap duration, or a start/end time of an upcoming repetition subset. In certain implementations, the second DCI needs to be sent at least certain time in advance of the upcoming repetition/gap to be applicable. For example, if the second DCI is received at least a threshold time before the start of an upcoming uplink repetition subset, then the UE 104 will modify the repetition pattern (e.g., gap duration or a start/end time) for the upcoming repetition subset; else, the UE 104 will transmit (and the NE 102 receive) the upcoming repetition subset in accordance with the previous repetition pattern and the UE 104 will apply the modified repetition pattern to subsequent repetition subsets. Beneficially, by updating the repetition pattern, the NE 102 and UE 104 can adapt the communication of the set of repetitions of the TB to improve communication throughput, effect power savings, and/or more effectively share communication resources with other users.

In further implementations, the NE 102 may later transmit a second DCI that indicates to the UE 104 to cancel the previously indicated/configured intra-set gaps between repetition subsets. In other words, the second DCI may indicate a modified repetition pattern where all remaining repetitions of the TB are transmitted consecutively, i.e., in a single repetition subset. Upon receiving the second DCI with the indication to cancel intra-set gaps, the UE 104 may transmit the remaining repetitions of the TB in consecutive manner with no intra-set gaps. Beneficially, by cancelling the previously indicated/configured intra-set gaps, the NE 102 and UE 104 can improve communication throughput by shortening the time to the last repetition of the TB. Additionally, the NE 102 and UE 104 can enter a lower-power state sooner by cancelling the previously indicated/configured intra-set gaps.

In some implementations, one or more of the intra-set gaps may be predetermined, such that their presence and/or location does not need to be indicated in the DCI transmitted by the NE 102. For example, one or more of the intra-set gaps may coincide with predetermined (e.g., preconfigured) Doppler cycles or satellite visibility windows. As another example, one or more of the intra-set gaps may coincide with discontinuous reception (DRX) cycles. However, for improved scheduling flexibility, certain types of predetermined values may be modified by the NE 102 transmitting (and the UE 104 may receiving) a second DCI, as described above, for example to extend the duration of an intra-set gap beyond the predetermined duration.

With regard to downlink transmission repetitions, in some implementations the NE 102 may transmit, a UE 104 may receive, a downlink allocation and the NE 102 may further configure the UE 104 to transmit certain uplink information (such as HARQ feedback, BSR, etc.) in one or more subset of the gaps. The NE 102 may indicate such opportunities for uplink transmission, e.g., in the repetition pattern.

In some implementations, the NE 102 may transmit a DCI scheduling a PDSCH transmission with a pattern of repetitions including multiple repetition subsets and at least one HARQ feedback opportunity (e.g., via PDSCH-to-HARQ or k₁ indication) based on the last repetition of the TB (e.g., as PDSCH reference) or, alternatively, based on a last repetition of some or all of the repetition subsets.

In some implementations, the NE 102 may transmit (and the UE 104 may receive) an indication of a repetition pattern that includes HARQ feedback opportunities. For example, the NE 102 may transmit the following pattern: {25, ‘30’, “3”, 45, ‘10’, 50, ‘35’, 70, “5”}; thereby indicating repetition subsets of 25, 45, 50, and 70 (i.e., 190 repetitions in total), with intra-set gaps of 30, 10, 35, and HARQ opportunities after “3” slots after the end of the first repetition subset, and after “5” slots after the end of the last repetition subset. In one example, the NE 102 transmits the indication of the repetition pattern in a scheduling DCI. Upon receiving the indication of the repetition pattern, the UE 104 determines the repetition pattern, including the one or more HARQ feedback opportunities, and communicates the set of repetitions and HARQ feedback in accordance with the determined pattern. Beneficially, by providing HARQ feedback, the NE 102 and UE 104 can determine if the TB is successfully received prior to an end of the set of repetitions, and/or can implement transmission adjustments (e.g., adaptation of an modulation and coding scheme (MCS) or a number of repetitions per slot) to improve the likelihood that the TB is successfully received by the counterpart device (i.e., the NE 102 for an uplink TB, or the UE 104 for a downlink TB).

In some implementations, a different redundancy version (RV) may be assigned to different repetition subsets. For example, the NE 102 may configure the one or more UEs 104 with RV information for the set of repetitions of the TB. In certain implementations, the NE 102 may transmit (and the UE 104 may receive) and indication of a repetition pattern, where the indicated repetition pattern may additionally include the RV sequence indication for the repetition subsets. In other implementations, the NE 102 may indicate the RV sequence separately from the repetition pattern, e.g., in another DCI or via RRC signaling. Alternatively, instead of the RV sequence being dynamically indicated to the UE 104, the NE 102 may pre-configure one or more RV sequences applicable to the repetition subsets. For example, the NE 102 may configure the UE 104 with a table with the set of repetitions patterns that is expanded to also include corresponding RV sequences for each repetition pattern in the table, or the NE 102 may configure the UE 104 with a second table of RV sequences and assistance information so that the UE 104 can determine which RV sequence to use for a particular repetition pattern.

For example, the NE 102 may use the RV sequence {0, 2, 3, 1} to indicate to the UE 104 that the repetitions of the first repetition subset are associated with RV 0, that the repetitions of the second repetition subset are associated with RV 2, that the repetitions of the third repetition subset are associated with RV 3, and that the repetition of the fourth repetition subset are associated with RV1. Consequently, upon receiving the RV sequence {0, 2, 3, 1}, the UE 104 may determine that the repetitions of the first repetition subset are associated with RV 0, that the repetitions of the second repetition subset are associated with RV 2, that the repetitions of the third repetition subset are associated with RV 3, and that the repetition of the fourth repetition subset are associated with RV1.

In some examples, the different repetitions within a repetition subset may have different RVs, e.g., based on the RV of the first repetition of the repetition subset and following an RV sequence. For example, the RV sequence may repeat (e.g., via modulo operation) for the set of repetitions of the TB.

In certain implementations, the UE 104 may be preconfigured to use different RV values for the different repetitions within the same repetition subset. Moreover, the UE 104 may be preconfigured with the sequence of RV value repetitions to use and/or with a means for determining (e.g., via modulo operation) which RV value to use. Alternatively, the NE 102 may indicate the sequence of RV value repetitions to use and/or the means for determining (e.g., via modulo operation) which RV value to use.

In certain other implementations, the NE 102 may transmit an indication to the UE 104 to use different RV values for the different repetitions within the same repetition subset. The NE 102 may further indicate the sequence of RV value repetitions to use and/or the means for determining (e.g., via modulo operation) which RV value to use. Alternatively, the UE 104 may be preconfigured with the sequence of RV value repetitions to use and/or with a means for determining (e.g., via modulo operation) which RV value to use when the NE 102 indicates that the UE 104 use different RV values for the different repetitions within the same repetition subset.

As another example, the NE 102 may use the repetition RV sequence of {0, 2, 3, 1} (i.e., for four RV possible values) to indicate to the UE 104 that the first repetition of first repetition subset has RV 0, the second repetition of first repetition subset has RV 2, the third repetition of first repetition subset has RV 3, the fourth repetition of first repetition subset has RV 1, etc. until the end of the first repetition subset, and also that the first repetition of second repetition subset has RV 2, the second repetition of second repetition subset has RV 3, the third repetition of second repetition subset has RV 1, the fourth repetition of second repetition subset has RV 0, etc. until the end of the first repetition subset, and also the first repetition of third repetition subset has RV 3, the second repetition of third repetition subset has RV 1, the third repetition of third repetition subset has RV 0, the fourth repetition of second repetition subset has RV 2, etc. until the end of the third repetition subset, and so on for all repetition subsets of the TB. Consequently, upon receiving the RV sequence {0, 2, 3, 1} and an indication (or being preconfigured) to use different RV values for the different repetitions within the same repetition subset, the UE 104 may determine that the first repetition of first repetition subset has RV 0, the second repetition of first repetition subset has RV 2, the third repetition of first repetition subset has RV 3, the fourth repetition of first repetition subset has RV 1, etc. until the end of the first repetition subset, and repetition RV sequences for the remaining repetition subsets, etc., as described above.

In some implementations, the NE 102 may configure the one or more UEs 104 with frequency hopping information for the set of repetitions of the TB. In some examples, the NE 102 may indicate (i.e., to the UE 104) an association between a frequency hopping pattern and different ones of the repetition subsets, such that each repetition subset is associated with a different frequency and the transceivers of the NE 102 and the UE 104 switch (i.e., hop) to the new frequency during the inter-set gap between successive repetition subsets. For example, the indication of the frequency hopping pattern transmitted by the NE 102 may indicate to the UE 104 that the first repetition subset is to use a first set of frequency resources, the second repetition subset (i.e., different than the first repetition subset) is to use a second set of frequency resources different than the first, etc. For such a frequency hopping configuration, the NE 102 may determine that the intra-set gap prior to such a frequency switch should satisfy (e.g., be larger than) a threshold duration, e.g., to accommodate the transceiver re-tuning to the new frequency. In one example, when a frequency hopping pattern is associated with the different repetition subsets, the NE 102 and the UE 104 abstain from frequency hopping between subsequent repetition subsets when the length (i.e., duration) of the intra-set gap does not satisfy the threshold duration. Because both the NE 102 and the UE 104 have knowledge of the intra-set gaps, the NE 102 and the UE 104 will both switch frequencies (or abstain from switching frequencies), thereby preserving synchronicity of the frequency hopping. In another example, when the frequency hopping pattern is associated with different repetition subsets, the NE 102 and the UE 104 may omit (i.e., abstain from communicating) one or more repetitions of the subsequent repetition subset, e.g., to accommodate re-tuning the transceiver to switch frequencies during the intra-set gap.

In some other examples, the NE 102 may indicate (i.e., to the UE 104) a frequency hopping pattern associated with different portions of the same repetition subset, such that the transceivers of the NE 102 and the UE 104 switch (i.e., hop) to a new frequency between successive repetitions within the same repetition subset. For example, the indication of the frequency hopping pattern transmitted by the NE 102 may indicate to the UE 104 that a first portion of the repetition subset is to use a first set of frequency resources, a second portion of the repetition subset is to use a second set of frequency resources different than the first, etc. For such a frequency hopping configuration, the UE 104 may skip (i.e., abstain from communicating) one or more repetitions within the repetition subset, e.g., to accommodate the transceiver re-tuning to the new frequency.

While the above descriptions describe dynamic grants of uplink and downlink resources, in further implementations the above repetition patterns may be extended to configured grants (e.g., configured uplink grants and/or configured downlink grants). As opposed to a dynamic grant, a configured grant refers to a semi-static allocation of resources which may be allocated using RRC signaling or higher-layer signaling, such that the UE 104 does not need to receive a grant in DCI before transmitting or receiving traffic (e.g., user data and/or control signaling) using the configured grant. In certain examples, the NE 102 may transmit (and the UE 104 may receive) a DCI that instructs the UE 104 to activate a previously configured grant of uplink and/or downlink resources. Moreover, each TB communicated over the configure grant resources (i.e., transmitted by the NE 102 to the UE 104 or transmitted by the UE 104 to the NE 102) may be communicated using a set of repetitions of the TB. In such implementations, the NE 102 may jointly configure the UE 104 with both the repetition pattern to be used to receive or transmit configured grant transmissions and the configured grant resources, and the UE 104 may receive or transmit the configured grant transmissions via a plurality of repetition subsets according to the jointly configured repetition pattern and communication resources.

In some implementations, the NE 102 may indicate to the UE 104 different time and/or frequency resources corresponding to different repetition subsets. For instance, the NE 102 may indicate (e.g., in the scheduling DCI) a bandwidth for the first repetition subset that is smaller than the bandwidth for the second repetition subset (or vice versa). Selecting different bandwidths for different repetition subsets may allow for more efficient network energy procedures at the NE 102, e.g., based on the activity of other UEs 104 (e.g., IoT and/or enhanced mobile broadband (eMBB) UEs) served by the NE 102.

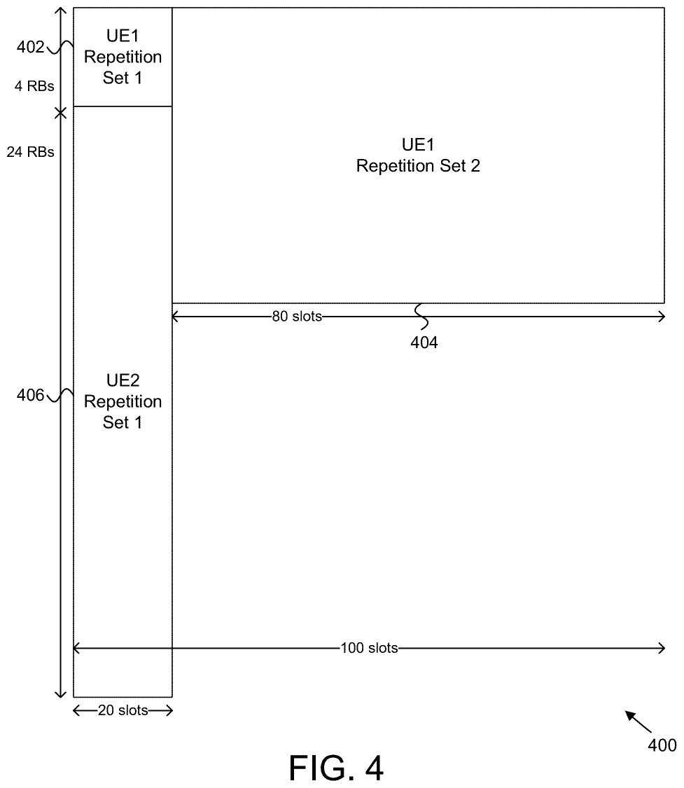

FIG. 4 illustrates a repetition pattern 400 for communication of a TB involving bandwidth adaptation between successive repetitions sets, in accordance with aspects of the present disclosure. In some examples, the repetition pattern 400 may implement or be implemented by aspects of the wireless communication system 100. For example, the repetition pattern 400 may be implemented by multiple UE 104 and/or multiple NE 102 as described with reference to FIG. 1. For example, the repetition pattern 400 may be associated with transmission and/or reception of TBs by multiple UEs, including a first UE (denoted “UE1”) and a second UE (denoted “UE2”). In some examples, the UE1 may be an IoT UE or a LPWA UE, while the UE2 may be an eMBB UE.

In the example of FIG. 4, an NE 102 may allocate (i.e., grant) resources to multiple UEs, such that the UE1 may be scheduled with a first set of resources for communicating (e.g., transmitting or receiving) a first TB using a set of N₁ repetitions over 100 slots comprising a first repetition subset 402 and a second repetition subset 404. The NE 102 may transmit (and the UE1 receive) a single DCI that includes a grant associated with both the first repetition subset 402 and the second repetition subset 404, as described above. Additionally, the NE 102 may allocate (i.e., grant) the UE2 with a second set of resources for communicating (e.g., transmitting or receiving) a second TB using a set of N₂ continuous repetitions over the first 20 of the 100 slots comprising a single repetition set 406. In certain implementations, the UE2 may receive a DCI scheduling (i.e., allocating) 24 resource blocks (RBs) during its 20 slots, while the UE1 receive a DCI scheduling (i.e., allocating) only 4 RBs during the first 20 slots (i.e., the. For example, the difference in RB allocations may be due to the capabilities of the UE1 and UE2 and/or due to the respective priorities of the first and second TBs.

However, after the UE2 is served (i.e., after the UE2 completes its scheduled repetitions for communicating (e.g., transmitting or receiving) the second TB, the NE 102 may modify the allocation to the UE1 such that the UE1 may be scheduled with 12 RBs during the remaining 80 slots. In the example of FIG. 4, the allocation of 4 RBs over the first 20 slots forms the first repetition subset 402, while the allocation of 12 RBs over the remaining 80 slots forms the second repetition subset 404. Accordingly, for an uplink TB, the UE1 may generate the first repetition subset 402 and the second repetition subset 404 for transmission of the uplink TB, while for a downlink TB, the NE 102 may generate the first repetition subset 402 and the second repetition subset 404 for transmission of the downlink TB. In one implementation, the DCI scheduling the first repetition subset 402 indicates the bandwidth modification for the second repetition subset 404 (i.e., comprising the remaining 80 slots). In another implementation, the NE 102 may transmit (and the UE 1 receive) a second DCI that indicates the bandwidth modification for the second repetition subset 404.

In certain implementations, the NE 102 and/or the UE 104 may aggregate a first repetition and a second repetition of the second repetition subset 404 in a single repetition with circular buffer rate matching and using the RV of the first repetition of the second repetition subset 404. While not depicted in FIG. 4, in other implementations there may be an intra-set gap between the first repetition subset 402 and the second repetition subset 404. That is, the NE 102 may indicate to the UE1 an intra-set gap between the first repetition subset 402 and the second repetition subset 404 using one or more of the techniques described herein.

In some implementations, the UE1 may adapt the bandwidth and the number of repetitions per slot within the scheduled repetitions, such as modifying the number of repetitions per slot in the second repetition subset 404 as compared to the first repetition subset 402. For example, during the first repetition subset 402 associated with a reduced bandwidth (e.g., 4 RB as shown in FIG. 4), the UE1 may be scheduled to communicate the first TB at a rate of 1 repetition per slot. Thereafter, during the second repetition subset 404 associated with an increased bandwidth (e.g., 12 RB as shown in FIG. 4), the UE1 may be scheduled to adapt (i.e., modify) the communicate the first TB at a rate of 3 repetition per slot.

For instance, if the UE1 was scheduled with 260 repetitions in the 100 slots, then the first repetition subset 402 will correspond to 20 repetitions of the first TB (i.e., 1 repetition per slot, over 20 slots). During the second repetition subset 404, the increased bandwidth (i.e., from 4 RB to 12 RB) supports more repetitions per slot thereby decreasing the time needed for the UE1 to perform the 260 repetitions of the first TB (i.e., 80 slots for the remaining 240 repetitions, rather than 240 slot were the number of repetition per slot not modified). In one implementation, the NE 102 may transmit to the UE1 an indication (e.g., instruction) that the UE1 adapts bandwidth and the number of repetitions per slot within the scheduled repetitions. In another implementation, the UE1 may be preconfigured to adapt the bandwidth and the number of repetitions per slot within the scheduled repetitions in accordance with the different time and/or frequency resources corresponding to different repetition subsets.

In certain implementations, the duration of the second repetition subset 404 may be adjusted according to the number of the repetitions of the second repetition subset 404 and the ratio of the bandwidth of the second repetition subset 404 over the bandwidth of the first repetition subset 402. Beneficially, a particular UE finishing the set of repetitions sooner can lead to energy savings as the NE 102 may be able to enter a sleep state (e.g., micro-sleep mode, light-sleep mode, or deep-sleep mode depending on the sleep time, and hardware components being shut down) after the last of the remaining 80 slots.

In certain implementations, to implement the repetition pattern 400 the NE 102 may transmit (and the UE1 may receive) a DCI that indicates the total number of slots and the bandwidth in each segment (i.e., 4 RBs in the first 20 slots and 12 RBs in the remaining 80 slots). Alternatively, the NE 102 may transmit (and the UE1 may receive) a DCI that indicates the length of each segment and the bandwidth in each segment.

In some implementations, upon receiving the indication of the repetition pattern 400 from the NE 102, the UE1 and/or the UE2 may determine the number of consecutive repetitions in each segment, i.e., based on the number of slots and allocated bandwidth in the one or more repetition subsets. In certain implementations, the UE1 and/or the UE2 may select the number of TB repetitions per slot based on the allocated bandwidth of a corresponding segment (i.e., repetition subset). For example, during the first repetition subset 402 associated with a reduced bandwidth (e.g., 4 RB as shown in FIG. 4), the NE 102 may schedule (i.e., allocate resource for) the UE1 to communicate the first TB at a rate of 1 repetition per slot. Additionally, the NE 102 may configure the UE1 to adapt (i.e., modify) to adapt its behavior during the second repetition subset 404 associated with an increased bandwidth (e.g., 12 RB as shown in FIG. 4) by communicating the first TB at a rate of 3 repetition per slot.

In some examples, the bandwidth for the second repetition subset 404 may be an integer multiple (e.g., 2× or 3×) of the bandwidth of the first repetition subset 402. In such a case, the repetitions also occur in frequency domain. For the scenario of a first repetition subset 402 having a bandwidth of 3 RB and a second repetition subset 404 having a bandwidth of 6 RB, the first repetition of the second repetition subset 404 occurs in the first half of the bandwidth (e.g., first 3 RBs), and the second repetition of the second repetition subset 404 occurs in the second half of the bandwidth (e.g., last 3 RBs). Accordingly, the wireless communication system 100 (e.g., the NE 102 and UE 104) may support enhanced coverage and/or compensate for poor channel conditions by adapting the number of repetitions per slot within the scheduled repetition subsets.

In some implementations, the UE1 may adapt the bandwidth and the MCS within the scheduled repetitions, such as modifying MCS in the second repetition subset 404 as compared to the first repetition subset 402. For example, during the first repetition subset 402 associated with a reduced bandwidth (e.g., 4 RB as shown in FIG. 4), the NE 102 may schedule (i.e., allocate resource for) the UE1 to communicate the first TB using a higher MCS value (i.e., corresponding to a larger modulation order and/or code rate) to encode more bits into each radio symbol. Additionally, the NE 102 may configure the UE1 to adapt (i.e., modify) to adapt its behavior during the second repetition subset 404 associated with an increased bandwidth (e.g., 12 RB as shown in FIG. 4) by communicating the first TB using a using a smaller MCS value (i.e., corresponding to a lower modulation order and/or code rate) to encode fewer bits into each radio symbol. Beneficially, using a smaller MCS value (i.e., a lower modulation order and/or a lower code rate) the transmission is more robust and the likelihood of successful decoding at the receiving device (i.e., the NE 102 or UE 104) increases.

In certain implementations, the UE1 may use the same number of repetitions per slot in both the first repetition subset 402 and the second repetition subset 404 and modify the MCS between repetition subsets associated with different bandwidths. In other implementations, the UE1 may jointly modify the MCS and the number of repetitions per slot as the bandwidth changes during different segments of the set of repetitions. Accordingly, the wireless communication system 100 (e.g., the NE 102 and UE 104) may support enhanced coverage and/or compensate for poor channel conditions by adapting the MCS within the scheduled repetition subsets.

In some implementations, the NE 102 may configure the UE1 to switch the waveform between repetition subsets (or different segments of the set of repetitions) the within the scheduled repetitions, such as using a different waveform in the second repetition subset 404 as compared to the first repetition subset 402. For example, during the first repetition subset 402 associated with the reduced bandwidth (e.g., 4 RB as shown in FIG. 4), both UEs (i.e., UE1 and UE2) are multiplexed, and hence the UE1 may use a CP-OFDM waveform to communicate the first TB. Thereafter, during the second repetition subset 404 associated with an increased bandwidth (e.g., 12 RB as shown in FIG. 4), the UE1 may switch to a discrete Fourier transform spread OFDM (DFT-S-OFDM) waveform, e.g., for better coverage. Beneficially, adapting the waveform within the scheduled repetitions may simplify the UE multiplexing procedure. As an example, the DFT-S-OFDM waveform may be used if the allocated bandwidth is larger than a certain threshold (e.g., 12 RBs).

In some implementations, in case of repetition of DCI, the NE 102 may define similar DCI repetition subsets and intra-DCI gap patterns (e.g., through RRC configuration and/or in a DCI indication). In certain implementations, the set of DCI repetitions may have different repetition resources and/or time units as compared to a set of data repetitions, i.e., of a TB. In certain implementations, the maximum number of DCI repetition subsets is smaller than the maximum number of data repetition subsets.

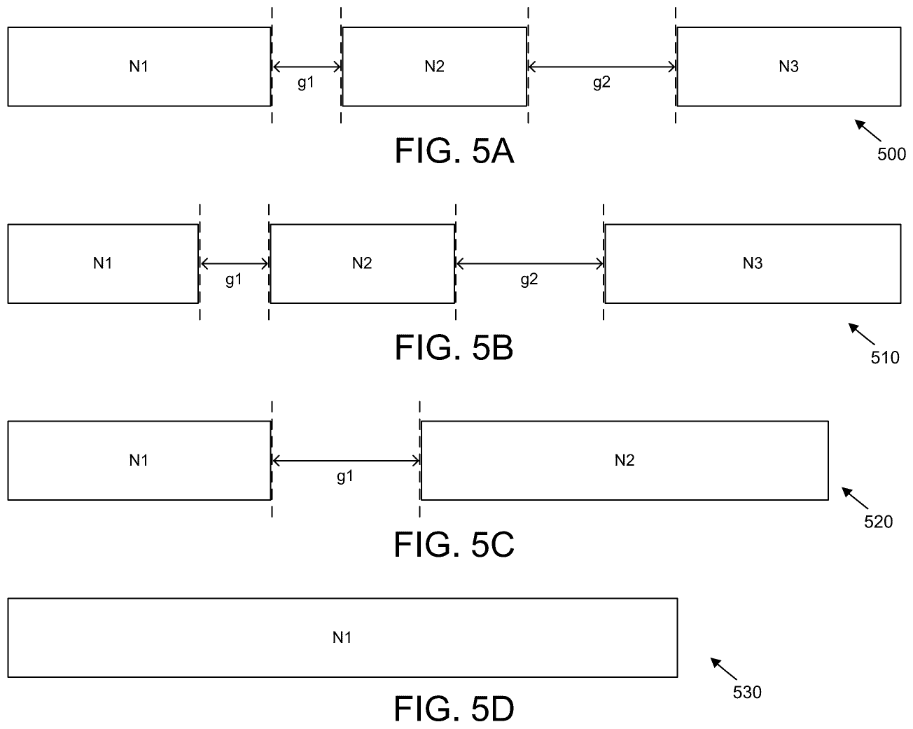

FIGS. 5A-5D illustrates example of patterns of repetitions for communication of a TB, in accordance with aspects of the present disclosure. In some examples, the patterns of repetitions may implement or be implemented by aspects of the wireless communication system 100. For example, an NE 102 may configure at least one UE 104 to transmit (or receive) a set of repetitions of a TB in accordance with the one of the depicted repetition patterns. As another example, the patterns of repetitions may be implemented by multiple UE 104 and/or multiple NE 102 as described with reference to FIG. 1.

FIG. 5A illustrates a first example of a pattern 500 of repetitions for communication of a TB, in accordance with aspects of the present disclosure. In some examples, the pattern 500 of repetitions may be implemented by aspects of the wireless communication system 100. For example, an NE 102 may configure at least one UE 104 to transmit a respective TB in accordance with the pattern 500 of repetitions. In another example, the NE 102 may configure the at least one UE 104 to receive a respective TB in accordance with the pattern 500 of repetitions. In the example of FIG. 5A, the pattern 500 of repetitions for communication of a TB may include multiple repetition subsets and gaps between successive repetition subsets, such that the UE 104 transmits (alternatively, the NE 102 transmits) and the NE 102 receives (alternatively, the UE 104 receives) a set of repetitions for the TB according to the pattern 500 of repetitions.

As depicted, the NE 102 may transmit (and the UE 104 may receive) a DCI that schedules a set of N repetitions of the TB, consisting of a first repetition subset including N₁ repetitions of the TB, a first intra-set gap of duration g₁, a second repetition subset including N₂ repetitions of the TB, a second intra-set gap of duration g₂, and a third repetition subset including N₃ repetitions of the TB, where N=N₁+N₂+N₃, and where the repetition subsets and the intra-set gaps form the pattern 500.

FIG. 5B illustrates a second example of a pattern 510 of repetitions for communication of a TB, in accordance with aspects of the present disclosure. In some examples, the pattern 510 of repetitions may be implemented by aspects of the wireless communication system 100. For example, an NE 102 may configure at least one UE 104 to transmit a respective TB in accordance with the pattern 510 of repetitions. In another example, the NE 102 may configure the at least one UE 104 to receive a respective TB in accordance with the pattern 510 of repetitions. In the example of FIG. 5B, the pattern 510 of repetitions for communication of a TB may include multiple repetition subsets and gaps between successive repetition subsets, such that the UE 104 transmits (alternatively, the NE 102 transmits) and the NE 102 receives (alternatively, the UE 104 receives) a set of repetitions for the TB according to the pattern 510 of repetitions.

As depicted, the NE 102 may transmit (and the UE 104 may receive) a DCI that schedules a set of N repetitions of a TB, consisting of a first repetition subset including N₁ repetitions of the TB, a first intra-set gap of duration g₁, a second repetition subset including N₂ repetitions of the TB, a second intra-set gap of duration g₂, and a third repetition subset including N₃ repetitions of the TB, where N=N₁+N₂+N₃ and N₁=N₂, and where the repetition subsets and the intra-set gaps form the pattern 510.

FIG. 5C illustrates a third example of a pattern 520 of repetitions for communication of a TB, in accordance with aspects of the present disclosure. In some examples, the pattern 520 of repetitions may be implemented by aspects of the wireless communication system 100. For example, an NE 102 may configure at least one UE 104 to transmit a respective TB in accordance with the pattern 520 of repetitions. In another example, the NE 102 may configure the at least one UE 104 to receive a respective TB in accordance with the pattern 520 of repetitions. In the example of FIG. 5C, the pattern 520 of repetitions for communication of a TB may include multiple repetition subsets and a gap between successive repetition subsets, such that the UE 104 transmits (alternatively, the NE 102 transmits) and the NE 102 receives (alternatively, the UE 104 receives) a set of repetitions for the TB according to the pattern 520 of repetitions.

As depicted, the NE 102 may transmit (and the UE 104 may receive) a DCI that schedules a set of N repetitions of a TB, consisting of a first repetition subset including N₁ repetitions of the TB, a first intra-set gap of duration g₁, and a second repetition subset including N₂ repetitions of the TB, where N=N₁+N₂, and where the repetition subsets and the intra-set gap form the pattern 520.

FIG. 5D illustrates a fourth example of a pattern 530 of repetitions for communication of a TB, in accordance with aspects of the present disclosure. In some examples, the pattern 530 of repetitions may be implemented by aspects of the wireless communication system 100. For example, an NE 102 may configure at least one UE 104 to transmit a respective TB in accordance with the pattern 530 of repetitions. In another example, the NE 102 may configure the at least one UE 104 to receive a respective TB in accordance with the pattern 530 of repetitions. In the example of FIG. 5D, the pattern 530 of repetitions for communication of a TB may include a single repetition subset, such that the UE 104 transmits (alternatively, the NE 102 transmits) and the NE 102 receives (alternatively, the UE 104 receives) a set of repetitions for the TB according to the pattern 530 of repetitions.

As depicted, the NE 102 may transmit (and the UE 104 may receive) a DCI that schedules a set of N repetitions of a TB, consisting of a first repetition subset including N₁ repetitions of the TB, where N=N₁. In one implementation, the pattern 530 represents a modified repetition pattern, for example, where the NE 102 has transmitted a later DCI that indicates to the UE 104 to cancel the previously indicated/configured gaps between repetition subsets.

In some examples, the NE 102 and/or UE 104 may select the gap values of the intra-set gaps from a set of configured values (e.g., in units of slots). In some examples, the NE 102 and/or UE 104 may select the gap values from a set of multiples of a basic unit. In one example, the ‘basic unit’ may be a function of ‘N₁’, such as g₁=N₁/C, where ‘C’ is the number of repetition subsets.

In some examples, the NE 102 and/or UE 104 may select the gap values as a function of the total number of repetitions ‘N’. For instance, the gap value g₁=a×b, for 512≤N≤1024; where a=2 and ‘b’ is indicated by DCI from a set of configured values.

In some examples, the NE 102 and/or UE 104 may select a gap value as a function of the preceding repetition subset. In one example, the gap value g₁ can be function of ‘N₁’ (e.g., the size of the first repetition set). In another example, the gap value g₂ can be function of ‘N₁+N₂’ (e.g., the total number of repetitions).

In some implementations, the NE 102 and/or UE 104 may define one or more intra-DCI gaps for the set of DCI repetitions according to a search space periodicity and/or a control region duration. Alternatively, the NE 102 may define a control region with variable length, and the NE 102 may indicate the length in the DCI transmitted to the UE 104, whereby the UE 104 determines a value for the variable length based on the DCI. For instance, the NE 102 may implement a two-stage (or multiple-stage) DCI, where the NE 102 indicates the control region length in a first DCI stage, and NE 102 indicates the number of DCI repetition subsets in the second DCI stage. Accordingly, the UE 104 may determine the intra-set gap between DCI repetition subsets based on the control region length and the number of DCI repetition subsets.

In some implementations, each repetition subset has a same length, i.e., N₁=N₂= . . . =N_{w}, and the NE 102 transmits (and the UE 104 receives) the scheduling DCI that indicates both the total number of repetitions, ‘N’, and the number of repetition subsets. In such implementations, the UE 104 determines the number of consecutive repetitions in each repetition subset (and/or duration of each repetition subset) from the DCI and splits (i.e., segments) the set of repetitions into a plurality of repetition subsets based on the determined number (or duration).

In some implementations, the NE 102 transmits (and the UE 104 receives) a scheduling DCI that does not indicate the total number of repetitions, ‘N’, but instead the UE 104 determines the value of ‘N’ based on the coverage level. In such implementations, the UE 104 and the NE 102 may uniquely identify the coverage level (e.g., via handshake signaling).

In some implementations, certain configured features may be only applicable within a repetition subset. For example, the NE 102 may configure a UE 104 with demodulation reference signal (DMRS) bundling that is applicable only during a set of data repetitions (i.e., of a TB) over a plurality of slots. As used herein, DMRS bundling is a technique that combines the DMRS from multiple data repetitions (e.g., uplink or downlink) to improve channel estimation, thereby enhancing coverage and improving decoding performance. For example, the NE 102 may schedule the UE 104 with a set of uplink data repetitions over a plurality of slots, and the UE 104 transmits DMRS along with user data in each repetition, such that the NE 102 collectively processes the DMRS from multiple (e.g., some or all) repetitions of the same data block.

In some implementations, the NE 102 may indicate (e.g., via dynamic signaling) that a set of slots is unavailable (e.g., so the NE 102 can enter a sleep state). Accordingly, the UE 104 may segment a scheduled set of repetitions of a TB into repetitions subsets according to the set of unavailable slots, such that the NE 102 is in the sleep state during the intra-set gap between successive repetition subsets.

In some implementations, if a UE 104 (e.g., an IoT device) has been scheduled with a set of ‘N’ repetitions of a TB, and after ‘N₁’ repetitions the cell goes to sleep (e.g., the NE 102 enters the sleep state), then the UE 104 may handle the remaining repetitions of the TB according to configured or indicated rules. In certain implementations, communication of a remainder of the repetitions (i.e., N−N₁) will be resumed after the cell wakes up. In one implementation, communication of the remainder of the repetitions may resume only if the sleep time of the network or the gap between repetition subsets is less than ‘T’ time units, where ‘T’ is a predetermined (or preconfigured) value.

In some implementations, the NE 102 may implicitly indicate, e.g., in the DCI, whether to resume communication of the remainder of the repetitions after the NE 102 wakes from the sleep state. In certain implementations, the NE 102 may transmit (and the UE 104 may receive) the DCI scheduling the ‘N’ repetitions, where the UE 104 is to resume communication (i.e., transmission or reception) of the remainder of the repetitions of the TB when ‘N’ satisfies a predetermined threshold. For example, a value of ‘N’ greater than a minimum value may implicitly signal to the UE 104 to resume communication of the remainder of the repetitions after the NE 102 wakes from the sleep state. Alternatively, a value of ‘N’ less than a maximum value may implicitly signal to the UE 104 to resume communication of the remainder of the repetitions after the NE 102 wakes from the sleep state. In some other implementations, the NE 102 may transmit an explicit indication whether to resume or cancel (i.e., terminate) communication of the remainder of the repetitions after the NE 102 wakes from the sleep state.

In certain implementations, the NE 102 and/or UE 104 may modify one or more configured and/or indicated features when a cell goes to sleep (i.e., the NE 102 enters a sleep mode) in the middle of the set of repetitions of the TB. For instance, DMRS bundling (if configured across multiple repetitions), may only be applicable to repetitions prior to the NE 102 entering a sleep mode (e.g., the cell going to sleep). In some examples, the NE 102 may separately indicate that DMRS bundling is applicable to repetitions after the cell wakes up from the sleep mode (i.e., after the NE 102 resumes the normal operating mode).

In certain implementations, the NE 102 may save the log-likelihood ratios (LLRs) representing the reliability of each received bit to a non-volatile memory of the NE 102, e.g., if memory power consumption is an issue depending on the sleep state, similar to context information (e.g., RRC configurations).

With regard to uplink transmission repetitions, in some implementations the UE 104 transmits the first repetition subset of N₁ PUSCH repetitions and then monitors the physical downlink control channel (PDCCH) in one or more PDCCH monitoring occasions during a monitoring window within the intra-set gap g₁ (e.g., within ‘x’ slots from the end of the gap g₁) and determines whether to resume or terminate (i.e., cancel) a remainder of the PUSCH repetitions. The UE 104 may perform a similar procedure at the end of the second repetition subset.

In certain implementations, if during the monitoring window the UE 104 receives a PDCCH indicating that the NE 102 has decoded the TB corresponding to the N₁ PUSCH repetitions, then the UE 104 stops transmitting a remainder of the PUSCH repetitions corresponding to that TB (i.e., skips the last N−N₁ repetitions). Otherwise, if during the monitoring window the UE 104 does not receive any PDCCH indicating successful reception of the TB, then the UE 104 starts transmitting the second repetition subset at the end of the first intra-set gap. In other words, if the UE 104 receives an ACK for the TB during a monitoring window within an intra-set gap, then the UE 104 skips transmission of the remaining repetitions, but if the UE 104 receives a NACK—or if no feedback is received—then the UE 104 transmits the next repetition subset after the intra-set gap.

Alternatively, the UE 104 may assume that the TB will be successfully decoded during the first repetition subset of N₁ PUSCH repetitions. Accordingly, if during the monitoring window the UE 104 receives a PDCCH indicating that the NE 102 has not decoded the TB corresponding to the N₁ PUSCH repetitions, then the UE 104 starts transmitting the second repetition subset at the end of the first intra-set gap. Otherwise, if during the monitoring window the UE 104 does not receive any PDCCH indicating unsuccessful reception of the TB, then the UE 104 stops transmitting a remainder of the PUSCH repetitions corresponding to that TB (i.e., skips the last N−N₁ repetitions). In other words, if the UE 104 receives a NACK for the TB during a monitoring window within an intra-set gap, then the UE 104 transmits the next repetition subset after the intra-set gap, but if the UE 104 receives an ACK—or if no feedback is received—then the UE 104 skips transmission of the remaining repetitions.

In some examples, the UE 104 may maintain (or be required to maintain) phase continuity and power consistency across at least adjacent repetition subsets. For example, there may be limits and/or requirements on the maximum allowable relative phase errors and power errors for each of one or more different intra-set gap lengths. In certain implementations, the UE 104 may implement an instruction to maintain phase continuity and power consistency under certain applicable conditions, such as: the UE 104 remaining in DRX active time (e.g., the UE 104 does not enter a DRX_OFF time), the UE 104 determining no change to a bandwidth part (BWP) of the UE 104 (i.e., the active BWP remains same), the UE 104 determining no occurrence of a measurement gap during an intra-set gap, the UE 104 determining an intra-set gap length is smaller than a threshold (e.g., 20 ms), etc. Note that a measurement gap refers to a scheduled period of time during which the UE 104 suspends communication with its serving cell (e.g., the NE 102) to perform measurements of other frequencies or RATs.

In some examples, the UE 104 may maintain (or be required to maintain) the phase continuity and power consistency for the repetitions within a repetition subset, but not across repetition subsets (e.g., if separated by an intra-set gap or when the gap length between repetition subsets is larger than a threshold). In certain implementations, the UE 104 may apply an instruction to maintain phase continuity and power consistency under certain applicable conditions, e.g., similar to those for DMRS bundling.

With regard to downlink transmission repetitions, in some implementations the NE 102 may configure the UE 104 with at most three repetition subsets, each repetition subset having a number of consecutive repetitions selected from one of two possible numbers of repetitions. Further, in some implementations, the length of each intra-set gap can have one of two possible values. Accordingly, the NE 102 may indicate the repetition pattern (i.e., the number and duration of the repetition subsets and the gaps between them) using a 5-bit sequence, i.e., a first bit to indicate the number of consecutive repetitions of the first repetition subset, a second bit to indicate the length of the first intra-set gap, a third bit to indicate the number of consecutive repetitions of the second repetition subset, a fourth bit to indicate the length of the second intra-set gap, and a fifth bit to indicate the number of consecutive repetitions of the third repetition subset. In such implementations, the NE 102 may transmit (e.g., in DCI) a 3-bit sequence to indicate a repetition pattern of only two repetition subsets with a single intra-set gap between the repetition subsets.

In some implementations, if the UE 104 is able to decode the TB after a repetition subset, then the UE 104 sends an ACK to the NE 102 during the intra-set gap. Upon receiving the ACK, the NE 102 terminates (i.e., cancels) a remainder of the repetitions of the TB. In such implementations, if the UE 104 is unable to decode the TB after a repetition subset, then the UE 104 does not transmit any feedback to the NE 102. Accordingly, if the NE 102 does not receive feedback (e.g., the ACK) during the intra-set gap, then the NE 102 transmits the next repetition subset after the intra-set gap.

In some implementations, the NE 102 may transmit (and the UE 104 receive) a DCI that indicates a set of k₁ values {e.g., k_{1_1}, k_{1_2}, k_{1_3}}, along with number of corresponding physical uplink control channel (PUCCH) repetitions, respectively corresponding to the first repetition subset, the second repetition subset, and the whole ‘N’ repetitions. The set of k₁ values is set of parameters indicating time delays (e.g., in terms of number of slots) between the repetition subsets of the TB (e.g., on the PDCCH) and the corresponding HARQ feedback opportunities. Accordingly, the k_{1_1} value indicates the HARQ feedback timing for the first repetition subset, the k_{1_2} value indicates the HARQ feedback timing for the second repetition subset, etc., and the last value in the set of k₁ values indicates the HARQ feedback timing for the set of ‘N’ repetitions as a whole.

According to aspects of a second solution, rather than segmenting the set of repetitions into a plurality of repetition subsets with intra-set gaps between successive repetition subsets, such that the NE 102 enters a sleep state (e.g., for energy saving at the NE 102), the NE 102 and/or UE 104 may instead interrupt a set of scheduled/configured repetitions (e.g., without previously defined gaps) when the NE 102 enters the sleep state. For instance, a UE 104 which has been scheduled for ‘N’ repetition, may also receive from the NE 102 (e.g., with the scheduling DCI or in a later indication) an indication of a gap or pause period. In one example, the NE 102 may transmit (and the UE 104 may receive) an indication to stop the repetitions completely after a certain time (e.g., next slot). In another example, the NE 102 may transmit (and the UE 104 may receive) a second DCI including an indication to interrupt (e.g., and later resume) the set of ‘N’ repetitions for a period of time (e.g., corresponding to a specified number of repetitions or a specified number of slots) starting after a certain time (e.g., starting in a next slot).

In some implementations, when a reference signal (RS) in a slot or a transmission occasion of a communication (e.g., uplink or downlink) overlaps with the indicated pause/gap period, the UE 104 may drop the communication in the slot or the transmission occasion. In other words, the UE 104 does not transmit an uplink RS in the overlapping slot/transmission occasion in uplink (UL), and the UE 104 is not expected to receive any downlink (DL) transmission (including a downlink RS) in the overlapping slot/transmission occasion in DL. In one example, the NE 102 may configure the UE 104 (e.g., via RRC signaling) to drop the RS transmission or omit the RS reception during the indicated pause/gap period. In another example, the NE 102 may transmit (and the UE 104 may receive) an indication to drop the RS transmission or omit the RS reception within the same DCI used to indicate/schedule the pause/gap period. In yet another example, the UE 104 may drop the RS transmission or omit the RS reception in accordance with preconfigured instructions and/or predefined rules.

In some implementations, for uplink transmissions, the NE 102 and/or UE 104 may resume communication of the repetitions of a TB after the NE 102 transmits an indication to resume. In certain implementations, the NE 102 and/or UE 104 may drop the repetitions overlapping with the indicated gap/pause period (i.e., the total number of repetitions of the TB will be less than an indicated amount based on the number of dropped repetitions). In certain other implementations, the NE 102 and/or UE 104 may postpone the repetitions overlapping with the indicated gap/pause period. For instance, when postponing repetitions, the total number of repetitions of the TB may remain unchanged but the NE 102 and/or UE 104 may extend a duration of the set of repetitions based on the number of postponed repetitions. Alternatively, the NE 102 and/or UE 104 may perform an transmission adaptation (e.g., performing more repetitions per slot) based on the number of postponed repetitions so that both the total number of repetitions of the TB and the duration of the set of repetitions remain the same. In one example, the NE 102 may configure the UE 104 (e.g., via RRC signaling) whether to postpone or drop the repetitions that overlap with the indicated pause/gap period. In another example, the NE 102 may transmit (and the UE 104 may receive) an indication whether to postpone or drop the overlapping repetitions within the same DCI used to indicate/schedule the pause/gap period. In yet another example, the UE 104 may postpone or drop the repetitions that overlap with the indicated pause/gap period reception in accordance with previously configured instructions and/or predetermined (e.g., predefined) rules.

In other implementations, the NE 102 and/or UE 104 may resume the postponed repetitions once certain conditions are satisfied. For instance, the NE 102 and/or UE 104 may transmit one or more postponed repetitions during a first valid slot which is at least certain number of slots after the end of the gap (e.g., 2 slots). In some examples, the number of slots may depend on an SCS used for transmission of the set of repetitions of the TB. For example, a larger SCS may correspond to a larger number of slots to wait before the NE 102 and/or UE 104 resumes the postponed repetitions.

In some implementations, the NE 102 and/or UE 104 may not maintain phase continuity between the two repetition subsets of repetitions (i.e., between the repetition subsets separated by the indicated pause/gap period). In certain implementations, the NE 102 may assign a different RV index to the second repetition subset (e.g., according to a modulo-operation formula). In such implementations, the NE 102 may transmit (and the UE 104 receive) an indication of the RV index assigned to the second repetition subset.

In some alternative implementations, the NE 102 may transmit (and the UE 104 may receive) a DCI that schedules the UE 104 with ‘N’ repetitions (i.e., where N=N₁+N₂) and, upon receiving (e.g., from the NE 102) indication or configuration of a pause/gap period, the UE 104 may drop the slots that overlap with the gap (or drop slots that contains a RS resource element (RE) which overlaps with the gap). Alternatively, upon receiving (e.g., from the NE 102) the indication or the configuration of the pause/gap period, the UE 104 may postpone the communication (i.e., transmission or reception) in the overlapped slots until the next slots (e.g., starting from a first slot satisfying some condition) not overlapping with the gap.

In some implementations, the NE 102 and/or UE 104 may support an early termination functionality. For example, the NE 102 may configure the UE 104 to terminate communication of the set of repetitions of a TB prior to completion of all repetitions. For a set of repetitions in the uplink, the NE 102 may transmit (and the UE 104 may receive) an ACK for an ongoing uplink transmission (e.g., a first uplink repetition subset of a plurality of uplink repetition subsets) or a DCI with new TB indication for same HARQ process. Alternatively, the NE 102 may transmit (and the UE 104 may receive) some explicit termination indication for uplink transmission. Upon receiving the ACK or termination indication, the UE 104 may cease transmitting a remainder of the set of uplink repetitions.

Similarly, for a set of repetitions in the downlink, the UE 104 may transmit (and the NE 102 may receive) an ACK for an ongoing downlink transmission (e.g., for a first downlink repetition subset of a plurality of downlink repetition subsets). Upon transmitting the ACK, the UE 104 is not expected to receive subsequent downlink repetition subsets of the same downlink transmission (and not expected to transmit corresponding ACK/NACK). Further, upon receiving the ACK, the NE 102 may cease transmitting a remainder of the set of downlink repetitions.

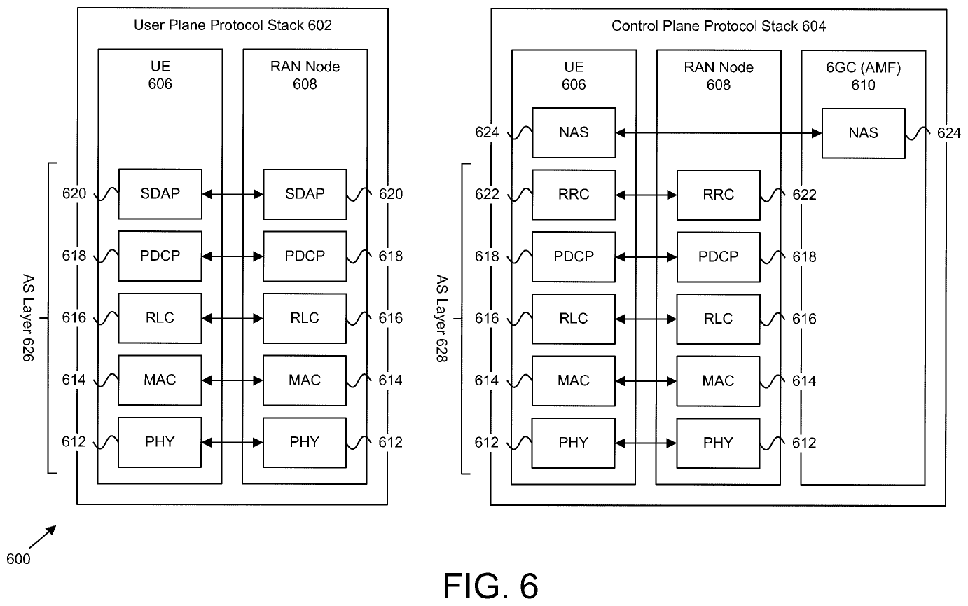

FIG. 6 illustrates an example of a protocol stack 600, in accordance with aspects of the present disclosure. While FIG. 6 shows a UE 606, a RAN node 608, and a 5GC 610 (e.g., including at least an AMF), these are representative of a set of UEs 104 interacting with an NE 102 (e.g., base station) and a CN 106. As depicted, the protocol stack 600 includes a user plane protocol stack 602 and a control plane protocol stack 604. The user plane protocol stack 602 includes a physical (PHY) layer 612, a MAC sublayer 614, a radio link control (RLC) sublayer 616, a packet data convergence protocol (PDCP) sublayer 618, and a service data adaptation protocol (SDAP) sublayer 620. The control plane protocol stack 604 includes a PHY layer 612, a MAC sublayer 614, an RLC sublayer 616, and a PDCP sublayer 618. The control plane protocol stack 604 also includes a RRC layer 622 and a non-access stratum (NAS) layer 624.

The AS layer 626 (also referred to as “AS protocol stack”) for the user plane protocol stack 602 consists of at least the SDAP sublayer 620, the PDCP sublayer 618, the RLC sublayer 616, the MAC sublayer 614, and the PHY layer 612. The AS layer 628 for the control plane protocol stack 604 consists of at least the RRC layer 622, the PDCP sublayer 618, the RLC sublayer 616, the MAC sublayer 614, and the PHY layer 612. The layer-1 (L1) includes the PHY layer 612. The layer-2 (L2) is split into the SDAP sublayer 620, PDCP sublayer 618, RLC sublayer 616, and MAC sublayer 614. The layer-3 (L3) includes the RRC layer 622 and the NAS layer 624 for the control plane and includes, e.g., an internet protocol (IP) layer and/or PDU layer (not depicted) for the user plane. L1 and L2 are referred to as “lower layers,” while L3 and above (e.g., transport layer, application layer) are referred to as “higher layers” or “upper layers.”

The PHY layer 612 offers transport channels to the MAC sublayer 614. The PHY layer 612 may perform a beam failure detection procedure using energy detection thresholds, as described herein. In certain implementations, the PHY layer 612 may send an indication of beam failure to a MAC entity at the MAC sublayer 614. The MAC sublayer 614 offers logical channels (LCHs) to the RLC sublayer 616. The RLC sublayer 616 offers RLC channels to the PDCP sublayer 618.

The PDCP sublayer 618 offers radio bearers to the SDAP sublayer 620 and/or RRC layer 622. The SDAP sublayer 620 offers QoS flows to the core network (e.g., 5GC). The RRC layer 622 provides for the addition, modification, and release of carrier aggregation (CA) and/or dual connectivity. The RRC layer 622 also manages the establishment, configuration, maintenance, and release of signaling radio bearers (SRBs) and data radio bearers (DRBs).

The NAS layer 624 is between the UE 606 and an AMF in the 5GC 610. NAS messages are passed transparently through the RAN. The NAS layer 624 is used to manage the establishment of communication sessions and for maintaining continuous communications with the UE 606 as it moves between different cells of the RAN. In contrast, the AS layers 626 and 628 are between the UE 606 and the RAN (i.e., RAN node 608) and carry information over the wireless portion of the network. While not depicted in FIG. 6, the IP layer exists above the NAS layer 624, a transport layer exists above the IP layer, and an application layer exists above the transport layer.

The MAC sublayer 614 is the lowest sublayer in the L2 architecture of the NR protocol stack. Its connection to the PHY layer 612 below is through transport channels, and the connection to the RLC sublayer 616 above is through LCHs. The MAC sublayer 614 therefore performs multiplexing and demultiplexing between LCHs and transport channels: the MAC sublayer 614 in the transmitting side constructs MAC PDUs (also known as TBs) from MAC service data units (SDUs) received through LCHs, and the MAC sublayer 614 in the receiving side recovers MAC SDUs from MAC PDUs received through transport channels.

The MAC sublayer 614 provides a data transfer service for the RLC sublayer 616 through LCHs, which are either control LCHs which carry control data (e.g., RRC signaling) or traffic LCHs which carry user plane data. On the other hand, the data from the MAC sublayer 614 is exchanged with the PHY layer 612 through transport channels, which are classified as UL or DL. Data is multiplexed into transport channels depending on how it is transmitted over the air.

The PHY layer 612 is responsible for the actual transmission of data and control information via the air interface, i.e., the PHY layer 612 carries all information from the MAC transport channels over the air interface on the transmission side. Some of the important functions performed by the PHY layer 612 include coding and modulation, link adaptation (e.g., adaptive modulation and coding (AMC)), power control, cell search and random access (for initial synchronization and handover purposes) and other measurements (inside the Third Generation Partnership Project (3GPP) system (i.e., NR and/or LTE system) and between systems) for the RRC layer 622. The PHY layer 612 performs transmissions based on transmission parameters, such as the modulation scheme, the coding rate (i.e., the MCS), the number of physical resource blocks (PRBs), etc.

In 5G NR, the resource block (RB) typically spans 12 subcarriers, and the bandwidth of the RB depends on the SCS used in the 5G NR system. For example, for 15 kHz SCS, the bandwidth of one RB is 180 kHz, while for 30 kHz SCS, the bandwidth of one RB is 360 kHz. Similarly, for 60 kHz SCS, the bandwidth of one RB is 720 kHz, while for 120 kHz SCS, the bandwidth of one RB is 1.44 MHz.

The duration of an RB in time is one slot, which may be composed of, e.g., 14 OFDM symbols in the time domain. In 5G NR, the time duration of an RB is based on the slot duration, which may vary according to the numerology and SCS used. For example, for 15 kHz SCS, the time duration of one RB (i.e., slot duration) is 1 ms, while for 30 kHz SCS, the time duration of one RB (slot duration) is 0.5 ms. Similarly, for 60 kHz SCS, the time duration of one RB (i.e., slot duration) is 0.25 ms, while for 120 kHz SCS, the time duration of one RB (slot duration) is 0.125 ms.

In some implementations, the protocol stack 600 may be an NR protocol stack used in a 5G NR system. An LTE protocol stack includes similar structure to the protocol stack 600, with the differences that the LTE protocol stack lacks the SDAP sublayer 620 in the AS layer 626, that an EPC replaces the 5GC 610, and that the NAS layer 624 is between the UE 606 and an MME in the EPC. Also, the present disclosure distinguishes between a protocol layer (such as the aforementioned PHY layer 612, MAC sublayer 614, RLC sublayer 616, PDCP sublayer 618, SDAP sublayer 620, RRC layer 622 and NAS layer 624) and a transmission layer in multiple-input multiple-output (MIMO) communication (also referred to as a “MIMO layer” or a “data stream”).

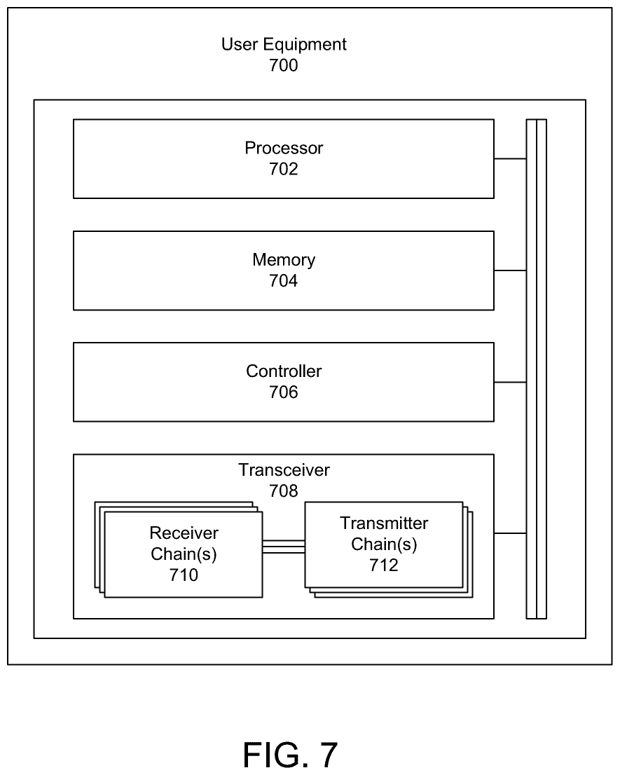

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field programmable gate array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions that, when executed by the processor 702, cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform various functions (e.g., operations, signaling) described herein (e.g., executing, by the processor 702, instructions stored in the memory 704). In some implementations, the processor 702 may include multiple processors and the memory 704 may include multiple memories. One or more of the multiple processors may be coupled with one or more of the multiple memories, which may be individually or collectively, configured to perform various functions (e.g., operations, signaling) of the UE 700 as described herein.

The processor 702 coupled with the memory 704 may be configured to, capable of, or operable to cause the UE 700 to receive a DCI including a grant for a set of repetitions of a TB; generate a plurality of repetition subsets from the set of repetitions for the TB, where the plurality of repetition subsets includes a first repetition subset including a first number of consecutive repetitions of the TB, and a second repetition subset including a second number of consecutive repetitions of the TB; and transmit the TB according to the plurality of repetition subsets, where each repetition subset is temporally offset from a subsequent repetition subset of the plurality of repetition subsets, and where a value of a respective offset between repetition subsets of the plurality of repetitions subsets is based at least in part on the received DCI.

In some implementations, the processor 702 coupled with the memory 704 may be configured to, capable of, or operable to cause the UE 700 to determine a number of consecutive repetitions for each of the plurality of repetition subsets based on the DCI. In certain implementations, a duration of the first repetition subset differs from a duration of the second repetition subset. Beneficially, supporting different durations of the repetition subsets allows for more flexibility when scheduling the set of repetitions of the TB.

In certain implementations, the DCI further indicates a first duration associated with the first repetition subset and a second duration associated with the second repetition subset. In such implementations, the processor 702 coupled with the memory 704 may be configured to, capable of, or operable to cause the UE 700 to: A) determine the first number of consecutive repetitions of the TB based on the first duration; and B) determine the second number of consecutive repetitions of the TB based on the second duration. Advantageously, the DCI overhead may be reduced when the UE 700 determines a number of consecutive repetitions for each of the plurality of repetition subsets, as the DCI does not need to include the number of consecutive repetitions for each of the plurality of repetition subsets.

In some implementations, the processor 702 coupled with the memory 704 may be configured to, capable of, or operable to cause the UE 700 to receive a second DCI including: A) an indication of a modified duration of at least one repetition subset of the plurality of repetition subsets, or B) an indication of a modified offset between subsequent repetition subsets of the plurality of repetition subsets, or both. Beneficially, supporting modification to the durations of the repetition subsets and/or offsets between subsequent repetition subsets allows for more flexibility when scheduling the set of repetitions of the TB.

In certain implementations, the second DCI indicates: A) an index of a respective repetition subset and a value for the modified duration, or B) an index of a respective repetition subset and a value for the modified offset, or both. In such implementations, the processor 702 coupled with the memory 704 may be configured to, capable of, or operable to cause the UE 700 to determine the modified duration of the specific repetition subset(s) and/or the modified offset between specific repetition subsets of the plurality of repetition subsets by looking up the index in a preconfigured set of values, as the DCI does not need to include explicit values for the modified duration and the specific repetition subset(s) and/or the modified offset and the relevant repetition subsets.

In certain implementations, the second DCI indicates an updated repetition pattern including a series of repetition subsets and a series of inter-set gaps between successive repetition subsets. In such implementations, the processor 702 coupled with the memory 704 may be configured to, capable of, or operable to cause the UE 700 to apply the updated repetition pattern to transmission of the TB beginning a predetermined time after a reception of the second DCI. Beneficially, supporting modification to the durations of the repetition subsets and/or inter-set gaps between subsequent repetition subsets allows for more flexibility when scheduling the set of repetitions of the TB. Moreover, by communicating the updated repetition pattern, the UE 700 does not need to receive additional DCI for subsequent repetitions subsets and thus may save power and/or computing resources.

In some implementations, the first repetition subset is associated with a first RV sequence, and the second repetition subset is associated with a second RV sequence different than the first RV sequence. Advantageously, by the UE 700 using different RV sequences, the network (e.g., base station) may improve decoding performance due to different sets of redundant parity bits in the repetitions. In some implementations, the processor 702 coupled with the memory 704 may be configured to, capable of, or operable to cause the UE 700 to apply DMRS bundling over contiguous repetitions of the TB. Beneficially, by applying DMRS bundling, the network (e.g., base station) may acquire a more accurate estimate of the radio channel.

In some implementations, the DCI comprises a first DCI part and a second DCI part. In some other implementations, the DCI consists of the first DCI part and the second DCI part. The second DCI part may be received in a set of DCI repetitions within a control region. In such implementations, the processor 702 coupled with the memory 704 may be configured to, capable of, or operable to cause the UE 700 to: A) receive the first DCI part; B) determine, based on the first DCI part, a length of the control region and a number of repetitions of the second DCI part; and C) determine a temporal offset between successive DCI repetition subsets based on the length of the control region and the number of repetitions of the second DCI part. In certain implementations, the processor 702 coupled with the memory 704 may be configured to, capable of, or operable to cause the UE 700 to receive the second DCI part according to the set of DCI repetitions. In certain implementations, the first repetition subset starts a predetermined time after a last repetition of the second DCI part. Advantageously, by receiving a set of DCI repetitions the UE 700 has improved likelihood of successfully decoding the second DCI part, thereby supporting high communication reliability and enhanced coverage.

In some implementations, the DCI further indicates whether the base station enters a sleep state between successive repetition subsets, or whether a remainder of the plurality of repetition subsets is to be communicated after the base station wakes from the sleep state, or both. Beneficially, by receiving an indication that the base station enters a sleep state, the UE 700 may also enter a sleep state during the intra-set gap between successive repetition subsets. Further, the indication of whether a remainder of the plurality of repetition subsets is to be communicated allows for synchronized behavior and common understanding between the UE 700 and the base station, thus minimizing interference caused by the UE 700 transmitting at a wrong time and preventing the base station from listening (i.e., monitoring) for a transmission at a time when the UE 700 is not transmitting.

In some implementations, the processor 702 coupled with the memory 704 may be configured to, capable of, or operable to cause the UE 700 to: A) receive a feedback indication that the TB was successfully decoded prior to transmission of an entirety of the plurality of repetition subsets; and B) cease transmitting a remainder of the plurality of repetition subsets in response to the feedback indication. Advantageously, by receiving the feedback from (e.g., from the base station) the UE 700 can terminate early the transmission of the set of repetitions, thereby conserving power, computing resources, and communication resources in the RAN.

In some implementations, the DCI further indicates a sequence of waveforms. In such implementations, to transmit the TB according to the plurality of repetition subsets, the processor 702 coupled with the memory 704 may be configured to, capable of, or operable to cause the UE 700 to apply each waveform of the sequence of waveforms to a corresponding repetition subset of the plurality of repetition subsets. Beneficially, by switching the sequence of waveforms for the plurality of repetition subsets the UE 700 can use a most efficient and/or most effective waveform, e.g., based at least in part on network conditions, thereby conserving power, computing resources, and/or communication resources.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

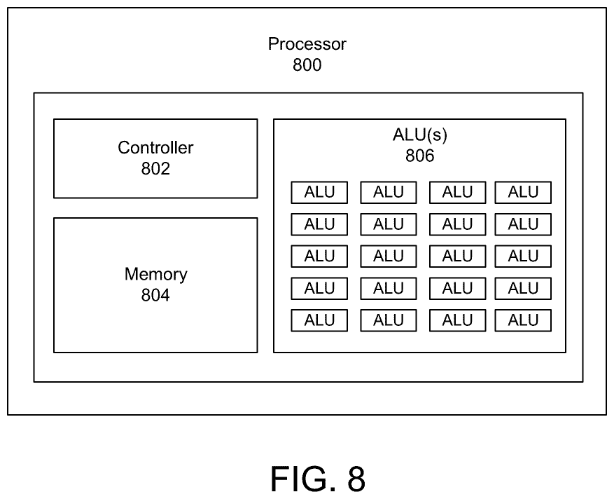

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1, or L2, or L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

In some implementations, the processor 800 may support various functions (e.g., operations, signaling) of a UE, in accordance with examples as disclosed herein. For example, the controller 802 coupled with the memory 804 may be configured to, capable of, or operable to cause the processor 800 to receive a DCI including a grant for a set of repetitions of a TB; generate a plurality of repetition subsets from the set of repetitions for the TB, where the plurality of repetition subsets includes a first repetition subset including a first number of consecutive repetitions of the TB, and a second repetition subset including a second number of consecutive repetitions of the TB; and transmit the TB according to the plurality of repetition subsets, where each repetition subset is temporally offset from a subsequent repetition subset of the plurality of repetition subsets, and where a value of a respective offset between repetition subsets of the plurality of repetitions subsets is based at least in part on the received DCI. Moreover, the controller 802 coupled with the memory 804 may be configured to, capable of, or operable to cause the processor 800 to perform one or more functions (e.g., operations, signaling) of the UE as described herein.

In certain implementations, the processor 800 may support various functions (e.g., operations, signaling) of a RAN node (e.g., base station or gNB), in accordance with examples as disclosed herein. For example, the controller 802 coupled with the memory 804 may be configured to, capable of, or operable to cause the processor 800 to transmit, to a UE, a DCI message including a grant for a set of repetitions of a TB; and receive the TB according to a plurality of repetition subsets, where the plurality of repetition subsets includes a first repetition subset including a first number of consecutive repetitions of the TB and a second repetition subset including a second number of consecutive repetitions of the TB, where each repetition subset is temporally offset from a subsequent repetition subset of the plurality of repetitions subsets, and where a value of a respective offset between repetition subsets of the plurality of repetition subsets is based at least in part on the transmitted DCI. Moreover, the controller 802 coupled with the memory 804 may be configured to, capable of, or operable to cause the processor 800 to perform one or more functions (e.g., operations, signaling) of the RAN node as described herein.

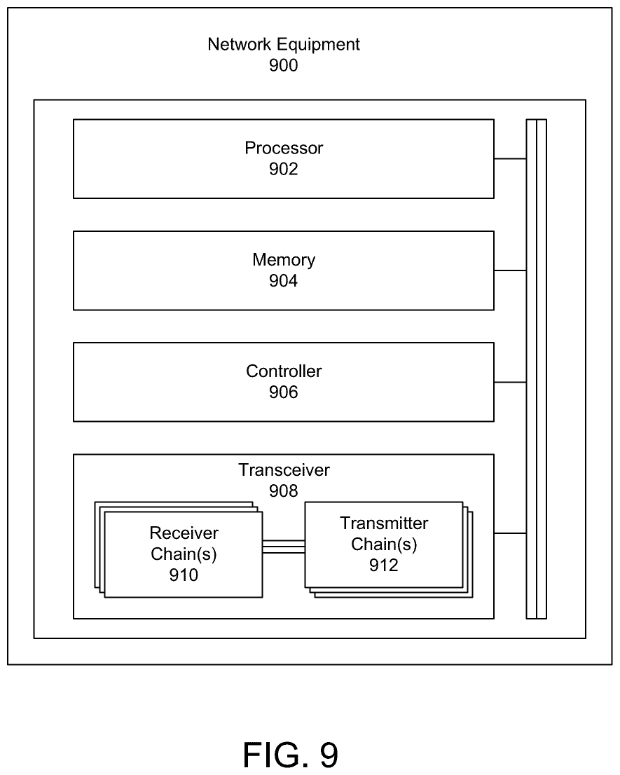

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform various functions (e.g., operations, signaling) described herein (e.g., executing, by the processor 902, instructions stored in the memory 904). In some implementations, the processor 902 may include multiple processors and the memory 904 may include multiple memories. One or more of the multiple processors may be coupled with one or more of the multiple memories, which may be individually or collectively, configured to perform various functions (e.g., operations, signaling) of the NE 900 as described herein.

The processor 902 coupled with the memory 904 may be configured to, capable of, or operable to cause the NE 900 to transmit, to a UE, a DCI message including a grant for a set of repetitions of a TB; and receive the TB according to a plurality of repetition subsets, where the plurality of repetition subsets includes a first repetition subset including a first number of consecutive repetitions of the TB and a second repetition subset including a second number of consecutive repetitions of the TB, where each repetition subset is temporally offset from a subsequent repetition subset of the plurality of repetitions subsets, and where a value of a respective offset between repetition subsets of the plurality of repetition subsets is based at least in part on the transmitted DCI.

In some implementations, the processor 902 coupled with the memory 904 may be configured to, capable of, or operable to cause the NE 900 to: A) determine an interval during which the base station forgoes communication with a set of UEs, where the respective offset between the repetition subsets corresponds to the determined interval; and B) enter a sleep state during the determined interval. In certain implementations, the DCI further indicates whether the base station enters a sleep state between successive repetition subsets. Advantageously, the NE 900 can improve network power savings by entering the sleep state during the intra-set gap between successive repetition subsets. Further, by transmitting the indication that the NE 900 is entering a sleep state during the intra-set gap, the set of UEs may also improve power savings by entering a sleep state during the intra-set gap or a portion thereof.

In certain implementations, the DCI further indicates: A) whether the UE is to resume transmission of a remainder of the plurality of repetition subsets after the base station wakes from the sleep state; B) whether the UE is to postpone scheduled communications that overlap with the determined interval; C) whether the UE is to drop scheduled communications that overlap with the determined interval; or a combination thereof. Beneficially, by transmitting the indication of whether a remainder of the plurality of repetition subsets is to be communicated (e.g., resumed, postponed, dropped) allows for synchronized behavior and common understanding between the NE 900 and the set of UEs, thus minimizing interference caused by the UEs transmitting at a wrong time and preventing the NE 900 from listening (i.e., monitoring) for a transmission at a time when no UE is transmitting.

In some implementations, the processor 902 coupled with the memory 904 may be configured to, capable of, or operable to cause the NE 900 to determine an amount of the plurality of repetition subsets for the TB based on a downlink buffer or on buffer status reporting from the UE, or both. Advantageously, by determining the amount of the plurality of repetition subsets for the TB based on the amount of traffic pending transmission (either downlink or uplink), the NE 900 can balance communication reliability with data latency and power savings.

In some implementations, the processor 902 coupled with the memory 904 may be configured to, capable of, or operable to cause the NE 900 to determine a number of consecutive repetitions for each of the plurality of repetition subsets and indicate the same in the DCI. Beneficially, the UE computing overhead may be reduced when the NE 900 determines the number of consecutive repetitions for each of the plurality of repetition subsets and indicates the same in the DCI.

In certain implementations, the DCI indicates a first duration associated with the first repetition subset and a second duration associated with the second repetition subset. In such implementations, the processor 902 coupled with the memory 904 may be configured to, capable of, or operable to cause the NE 900 to: A) determine the first number of consecutive repetitions of the TB based on the first duration; and B) determine the second number of consecutive repetitions of the TB based on the second duration. Advantageously, the NE 900 may reduce decoding complexity by determining an expected amount of repetitions of the TB to receive in each repetition subset. In certain implementations, a duration of the first repetition subset differs from a duration of the second repetition subset. Beneficially, supporting different durations of the repetition subsets allows for more flexibility when scheduling the set of repetitions of the TB.

In some implementations, the DCI comprises a first DCI part and a second DCI part. In some other implementations, the DCI consists of the first DCI part and the second DCI part. The second DCI part may be transmitted in a set of DCI repetitions within a control region. In certain implementations, the processor 902 coupled with the memory 904 may be configured to, capable of, or operable to cause the NE 900 to: A) transmit the first DCI part indicating a length of the control region and a number of repetitions of the second DCI part; and B) transmit the second DCI part according to the set of DCI repetitions. In such implementations, a temporal offset between successive DCI repetition subsets may be based on the length of the control region and the number of repetitions of the second DCI part. In certain implementations, the first repetition subset starts a predetermined time after a last repetition of the second DCI part. Advantageously, by receiving a set of DCI repetitions the NE 900 has improved likelihood of successfully decoding the second DCI part, thereby supporting high communication reliability and enhanced coverage.

In some implementations, the processor 902 coupled with the memory 904 may be configured to, capable of, or operable to cause the NE 900 to: A) determine, based on a received portion of the plurality of repetition subsets, whether the TB was successfully decoded; and B) transmit, to the UE, an indication that the TB was successfully decoded prior to transmission of an entirety of the plurality of repetition subsets. Beneficially, by the NE 900 transmitting the feedback to the UE, the UE can terminate early the transmission of the set of repetitions, thereby conserving power, computing resources, and communication resources in the NE 900.

In some implementations, the processor 902 coupled with the memory 904 may be configured to, capable of, or operable to cause the NE 900 to transmit a second DCI including: A) an indication of a modified duration of at least one repetition subset of the plurality of repetition subsets, or B) an indication of a modified offset between subsequent repetition subsets of the plurality of repetition subsets, or both. Advantageously, supporting modification to the durations of the repetition subsets and/or offsets between subsequent repetition subsets allows for more flexibility when scheduling the set of repetitions of the TB.

In certain implementations, the second DCI indicates: A) an index of a respective repetition subset and a value for the modified duration, or B) an index of a respective repetition subset and a value for the modified offset, or both. In such implementations, the processor 902 coupled with the memory 904 may be configured to, capable of, or operable to cause the NE 900 to determine the modified duration of the specific repetition subset(s) and/or the modified offset between specific repetition subsets of the plurality of repetition subsets by looking up the index in a preconfigured set of values. Beneficially, the DCI does not need to include explicit values for the modified duration and the specific repetition subset(s) and/or the modified offset and the relevant repetition subsets, thereby reducing overhead and conserving communication resources.

In certain implementations, the second DCI indicates an updated repetition pattern including a series of repetition subsets and a series of inter-set gaps between successive repetition subsets. In such implementations, the processor 902 coupled with the memory 904 may be configured to, capable of, or operable to cause the NE 900 to apply the updated repetition pattern to reception of the TB beginning a predetermined time after a transmission of the second DCI. Advantageously, supporting modification to the durations of the repetition subsets and/or inter-set gaps between subsequent repetition subsets allows for more flexibility when scheduling the set of repetitions of the TB. Moreover, by communicating the updated repetition pattern, the NE 900 does not need to later transmit additional DCI for subsequent repetitions subsets and thus may save power and/or computing resources.

In some implementations, the first repetition subset is associated with a first RV sequence, and the second repetition subset is associated with a second RV sequence different than the first RV sequence. Advantageously, because of the different RV sequences, the NE 900 may improve decoding performance due to different sets of redundant parity bits in the repetitions.

In some implementations, the DCI further indicates a sequence of waveforms. In such implementations, to receive the TB according to the plurality of repetition subsets, the processor 902 coupled with the memory 904 may be configured to, capable of, or operable to cause the NE 900 to apply each waveform of the sequence of waveforms to a corresponding repetition subset of the plurality of repetition subsets. Beneficially, by switching the sequence of waveforms for the plurality of repetition subsets the NE 900 can use a most efficient and/or most effective waveform, e.g., based at least in part on network conditions, thereby conserving power, computing resources, and/or communication resources.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

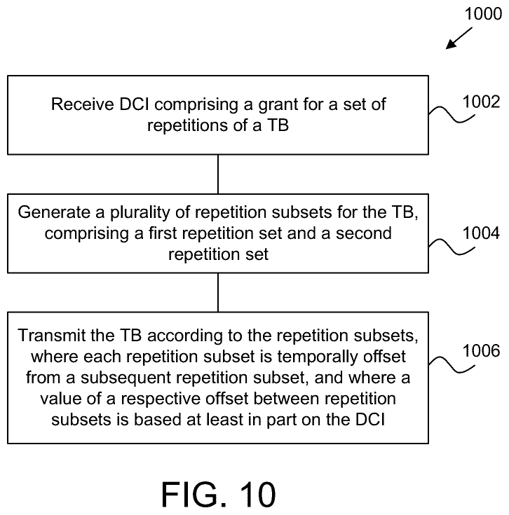

FIG. 10 illustrates a flowchart of a method 1000 in accordance with aspects of the present disclosure. The operations of the method 1000 may be implemented by a UE as described herein. In some implementations, the UE may execute a set of instructions to control the function elements of the UE to perform the described functions.

At step 1002, the method 1000 may include receiving a DCI including a grant for a set of repetitions of a TB. The operations of step 1002 may be performed in accordance with examples as described herein. In some implementations, aspects of the operations of step 1002 may be performed by a UE, as described with reference to FIG. 7.

At step 1004, the method 1000 may include generating a plurality of repetition subsets from the set of repetitions for the TB, where the plurality of repetition subsets includes a first repetition subset including a first number of consecutive repetitions of the TB, and a second repetition subset including a second number of consecutive repetitions of the TB. The operations of step 1004 may be performed in accordance with examples as described herein. In some implementations, aspects of the operations of step 1004 may be performed by a UE, as described with reference to FIG. 7.

At step 1006, the method 1000 may include transmitting the TB according to the plurality of repetition subsets, where each repetition subset is temporally offset from a subsequent repetition subset of the plurality of repetition subsets, and where a value of a respective offset between repetition subsets of the plurality of repetitions subsets is based at least in part on the received DCI. The operations of step 1006 may be performed in accordance with examples as described herein. In some implementations, aspects of the operations of step 1006 may be performed by a UE, as described with reference to FIG. 7.

It should be noted that the method 1000 described herein describes one possible implementation, and that the operations and the steps may be rearranged or otherwise modified and that other implementations are possible.

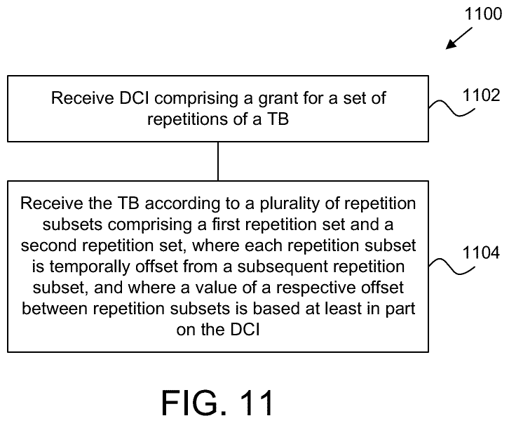

FIG. 11 illustrates a flowchart of a method 1100 in accordance with aspects of the present disclosure. The operations of the method 1100 may be implemented by a UE as described herein. In some implementations, the UE may execute a set of instructions to control the function elements of the UE to perform the described functions.

At step 1102, the method 1100 may include receiving a DCI including a grant for a set of repetitions of a TB. The operations of step 1102 may be performed in accordance with examples as described herein. In some implementations, aspects of the operations of step 1102 may be performed by a UE, as described with reference to FIG. 7.

At step 1104, the method 1100 may include receiving the TB according to a plurality of repetition subsets, where the plurality of repetition subsets includes a first repetition subset including a first number of consecutive repetitions of the TB and a second repetition subset including a second number of consecutive repetitions of the TB, where each repetition subset is temporally offset from a subsequent repetition subset of the plurality of repetitions subsets, and where a value of a respective offset between repetition subsets of the plurality of repetition subsets is based at least in part on the transmitted DCI. The operations of step 1104 may be performed in accordance with examples as described herein. In some implementations, aspects of the operations of step 1104 may be performed by a UE, as described with reference to FIG. 7.

It should be noted that the method 1100 described herein describes one possible implementation, and that the operations and the steps may be rearranged or otherwise modified and that other implementations are possible.

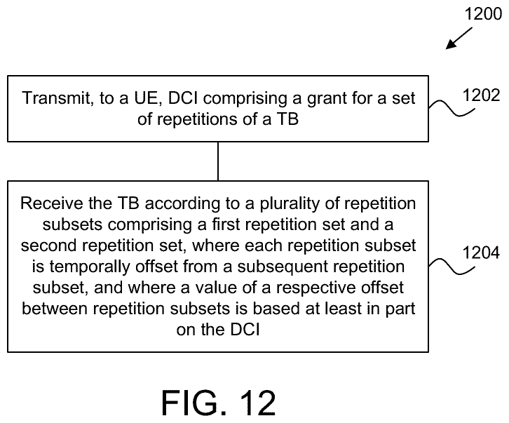

FIG. 12 illustrates a flowchart of a method 1200 in accordance with aspects of the present disclosure. The operations of the method 1200 may be implemented by a base station, such as an NE as described herein. In some implementations, the base station may execute a set of instructions to control the function elements of the base station to perform the described functions.

At step 1202, the method 1200 may include transmitting, to a UE, a DCI message including a grant for a set of repetitions of a TB. The operations of step 1202 may be performed in accordance with examples as described herein. In some implementations, aspects of the operations of step 1202 may be performed by a NE, as described with reference to FIG. 9.

At step 1204, the method 1200 may include receiving the TB according to a plurality of repetition subsets, where the plurality of repetition subsets includes a first repetition subset including a first number of consecutive repetitions of the TB and a second repetition subset including a second number of consecutive repetitions of the TB, where each repetition subset is temporally offset from a subsequent repetition subset of the plurality of repetitions subsets, and where a value of a respective offset between repetition subsets of the plurality of repetition subsets is based at least in part on the transmitted DCI. The operations of step 1204 may be performed in accordance with examples as described herein. In some implementations, aspects of the operations of step 1204 may be performed by a NE, as described with reference to FIG. 9.

It should be noted that the method 1200 described herein describes one possible implementation, and that the operations and the steps may be rearranged or otherwise modified and that other implementations are possible.

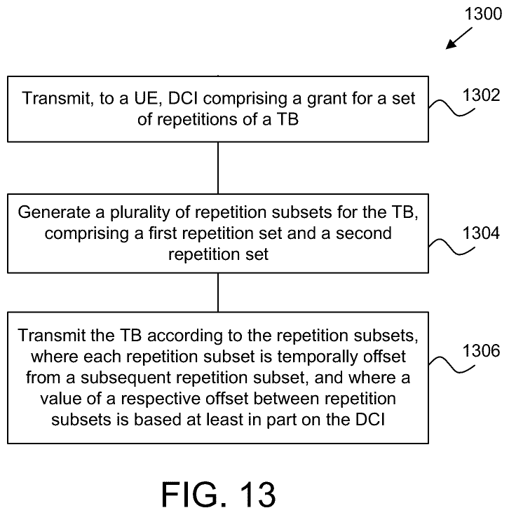

FIG. 13 illustrates a flowchart of a method 1300 in accordance with aspects of the present disclosure. The operations of the method 1300 may be implemented by a base station, such as an NE as described herein. In some implementations, the base station may execute a set of instructions to control the function elements of the base station to perform the described functions.

At step 1302, the method 1300 may include transmitting, to a UE, a DCI message including a grant for a set of repetitions of a TB. The operations of step 1302 may be performed in accordance with examples as described herein. In some implementations, aspects of the operations of step 1302 may be performed by a NE, as described with reference to FIG. 9.

At step 1304, the method 1300 may include generating a plurality of repetition subsets from the set of repetitions for the TB, where the plurality of repetition subsets includes a first repetition subset including a first number of consecutive repetitions of the TB, and a second repetition subset including a second number of consecutive repetitions of the TB. The operations of step 1304 may be performed in accordance with examples as described herein. In some implementations, aspects of the operations of step 1304 may be performed by a NE, as described with reference to FIG. 9.

At step 1306, the method 1300 may include transmitting the TB according to the plurality of repetition subsets, where each repetition subset is temporally offset from a subsequent repetition subset of the plurality of repetition subsets, and where a value of a respective offset between repetition subsets of the plurality of repetitions subsets is based at least in part on the received DCI. The operations of step 1306 may be performed in accordance with examples as described herein. In some implementations, aspects of the operations of step 1304 may be performed by a NE, as described with reference to FIG. 9.

It should be noted that the method 1300 described herein describes one possible implementation, and that the operations and the steps may be rearranged or otherwise modified and that other implementations are possible.

What is claimed is:

1. A user equipment (UE) for wireless communication, comprising:
at least one memory; and
at least one processor coupled with the at least one memory and configured to cause the UE to:
receive a downlink control information (DCI) comprising a grant for a set of repetitions of a transport block (TB);
generate a plurality of repetition subsets from the set of repetitions for the TB, wherein the plurality of repetition subsets comprises a first repetition subset including a first number of consecutive repetitions of the TB, and a second repetition subset including a second number of consecutive repetitions of the TB; and
transmit the TB according to the plurality of repetition subsets, wherein each repetition subset is temporally offset from a subsequent repetition subset of the plurality of repetition subsets, and wherein a value of a respective offset between repetition subsets of the plurality of repetition subsets is based at least in part on the received DCI.

2. The UE of claim 1, wherein the at least one processor is configured to cause the UE to determine a number of consecutive repetitions for each repetition subset of the plurality of repetition subsets based on the DCI and generate the plurality of repetition subsets based on the determined number of consecutive repetitions for each repetition subset.

3. The UE of claim 2, wherein the DCI further indicates a first duration associated with the first repetition subset and a second duration associated with the second repetition subset, wherein the at least one processor is configured to cause the UE to:
determine the first number of consecutive repetitions of the TB based on the first duration; and
determine the second number of consecutive repetitions of the TB based on the second duration.

4. The UE of claim 1, wherein the at least one processor is configured to cause the UE to receive a second DCI comprising:
an indication of a modified duration of at least one repetition subset of the plurality of repetition subsets, or
an indication of a modified offset between subsequent repetition subsets of the plurality of repetition subsets.

5. The UE of claim 4, wherein the second DCI indicates:
an index of a respective repetition subset and a value for the modified duration, or
an index of a respective repetition subset and a value for the modified offset.

6. The UE of claim 4, wherein the second DCI indicates an updated repetition pattern comprising a series of repetition subsets and a series of inter-set gaps between successive repetition subsets, wherein the at least one processor is configured to cause the UE to apply the updated repetition pattern to transmission of the TB beginning a predetermined time after a reception of the second DCI.

7. The UE of claim 1, wherein the first repetition subset is associated with a first redundancy version (RV) sequence and the second repetition subset is associated with a second RV sequence different than the first RV sequence.

8. The UE of claim 1, wherein the at least one processor is configured to cause the UE to apply DMRS bundling over contiguous repetitions of the TB, and wherein a duration of the first repetition subset differs from a duration of the second repetition subset.

9. The UE of claim 1, wherein the DCI comprises a first DCI part and a second DCI part, wherein the second DCI part is received in a set of DCI repetitions within a control region, and wherein the at least one processor is configured to cause the UE to:
determine, based on the first DCI part, a length of the control region and a number of repetitions of the second DCI part; and
determine a temporal offset between successive DCI repetition subsets based on the length of the control region and the number of repetitions of the second DCI part.

10. The UE of claim 1, wherein the DCI further indicates whether a base station enters a sleep state between successive repetition subsets, or whether a remainder of the plurality of repetition subsets is to be communicated after the base station wakes from the sleep state, or both.

11. The UE of claim 1, wherein the at least one processor is configured to cause the UE to:
receive a feedback indication that the TB was successfully decoded prior to transmission of an entirety of the plurality of repetition subsets; and
cease transmitting a remainder of the plurality of repetition subsets in response to the feedback indication.

12. The UE of claim 1, wherein the DCI further indicates a sequence of waveforms, and wherein to transmit the TB according to the plurality of repetition subsets, the at least one processor is configured to cause the UE to apply each waveform of the sequence of waveforms to a corresponding repetition subset of the plurality of repetition subsets.

13. A method performed by a UE, the method comprising:
receiving a downlink control information (DCI) comprising a grant for a set of repetitions of a transport block (TB);
generating a plurality of repetition subsets from the set of repetitions for the TB, wherein the plurality of repetition subsets comprises a first repetition subset including a first number of consecutive repetitions of the TB, and a second repetition subset including a second number of consecutive repetitions of the TB; and
transmitting the TB according to the plurality of repetition subsets, wherein each repetition subset is temporally offset from a subsequent repetition subset of the plurality of repetition subsets, and wherein a value of a respective offset between repetition subsets of the plurality of repetitions subsets is based at least in part on the received DCI.

14. A method performed by a base station, the method comprising:
transmitting, to a user equipment (UE), a downlink control information (DCI) message comprising a grant for a set of repetitions of a transport block (TB); and
receiving the TB according to a plurality of repetition subsets, wherein the plurality of repetition subsets comprises a first repetition subset including a first number of consecutive repetitions of the TB, and a second repetition subset including a second number of consecutive repetitions of the TB,
wherein each repetition subset is temporally offset from a subsequent repetition subset of the plurality of repetitions subsets, and wherein a value of a respective offset between repetition subsets of the plurality of repetition subsets is based at least in part on the transmitted DCI.

15. The method of claim 14, further comprising:
determining an interval during which the base station forgoes communication with a set of UEs, wherein the respective offset between the repetition subsets corresponds to the determined interval; and
entering a sleep state during the determined interval.

16. The method of claim 15, wherein the DCI further indicates:
whether the UE is to resume transmission of a remainder of the plurality of repetition subsets after the base station wakes from the sleep state;
whether the UE is to postpone scheduled communications that overlap with the determined interval; or
whether the UE is to drop scheduled communications that overlap with the determined interval.

17. The method of claim 14, further comprising determining an amount of the plurality of repetition subsets for the TB based on a downlink buffer or on buffer status reporting from the UE, or both.

18. The method of claim 14, wherein the DCI comprises a first DCI part and a second DCI part, wherein the second DCI part is transmitted in a set of DCI repetitions within a control region, the method further comprising:
transmitting the first DCI part indicating a length of the control region and a number of repetitions of the second DCI part; and
transmitting the second DCI part according to the set of DCI repetitions,
wherein a temporal offset between successive DCI repetition subsets is based on the length of the control region and the number of repetitions of the second DCI part, and wherein the first repetition subset starts a predetermined time after a last repetition of the second DCI part.

19. The method of claim 14, further comprising:
determining, based on a received portion of the plurality of repetition subsets, whether the TB was successfully decoded; and
transmitting, to the UE, an indication that the TB was successfully decoded prior to transmission of an entirety of the plurality of repetition subsets.

20. A base station for wireless communication, comprising:
at least one memory; and
at least one processor coupled with the at least one memory and configured to cause the base station to:
transmit, to a user equipment (UE), a downlink control information (DCI) message comprising a grant for a set of repetitions of a transport block (TB); and
receive the TB according to a plurality of repetition subsets, wherein the plurality of repetition subsets comprises a first repetition subset including a first number of consecutive repetitions of the TB, and a second repetition subset including a second number of consecutive repetitions of the TB, wherein each repetition subset is temporally offset from a subsequent repetition subset of the plurality of repetitions subsets, and wherein a value of a respective offset between repetition subsets of the plurality of repetition subsets is based at least in part on the transmitted DCI.
